(19) United States
(12) Patent Application Publication
(10) Pub. No.: US 2018/0272314 A1
(43) Pub. Date: Sep. 27, 2018

(54) GAS PURIFICATION WITH DIAMINE-APPENDED METAL-ORGANIC FRAMEWORKS

(71) Applicants: The Regents of the University of California, Oakland, CA (US); Chevron U.S.A. Inc., San Ramon, CA (US)

(72) Inventors: Jeffrey R. Long, Oakland, CA (US); Thomas M. McDonald, Berkeley, CA (US); Rebecca L. Siegelman, Berkeley, CA (US); Joshua A. Thompson, Martinez, CA (US)

(21) Appl. No.: 15/763,822

(22) PCT Filed: Sep. 29, 2016
(86) PCT No.: PCT/US2016/054530

§ 371 Date: Mar. 27, 2018

Related U.S. Application Data
(60) Provisional application No. 62/235,252, filed on Sep. 30, 2015.

(51) Int. Cl. B01J 20/22; C07F 3/00; B01D 53/04; B01D 53/047

(52) U.S. Cl. CPC B01J 20/226; C07F 3/003; B01D 53/0462; B01D 53/047; B01D 2256/245; B01D 2257/504; B01D 2257/304; B01D 2257/308; B01D 2253/204

(57) ABSTRACT

The disclosure provides for diamine-appended metal-organic frameworks (MOFs), methods of making thereof, and methods of use thereof.

### CROSS REFERENCE TO RELATED APPLICATIONS

This application claims priority under 35 U.S.C. § 119 from Provisional Application Ser. No. 62/235,252, filed Sep. 30, 2015, the disclosures of which are incorporated herein by reference.

### TECHNICAL FIELD

The disclosure provides for diamine-appended metal-organic frameworks, methods of making thereof, and methods of use thereof.

### BACKGROUND

Metal-organic frameworks (MOFs) are porous crystalline materials that are constructed by linking metal clusters called Secondary Binding Units (SBUs) and organic linking ligands. MOFs have high surface area and high porosity which enable them to be utilized in diverse fields, such as gas storage, catalysis, and sensors.

### SUMMARY

The disclosure provides an innovative approach to separating CO₂ and other acid gases from fuel gas. In particular, the disclosure provides for diamine-appended metal organic frameworks (MOFs), such as ee-2-Mg₂(dobpdc) and ii-2-Mg₂(dobpdc) (ee=N,N-diethylethylenediamine; ii=N,N-diisopropylethylenediamine; dobpdc⁴⁻=4,4′-dioxidobiphenyl-3,3′-dicarboxylate), that are capable of adsorbing CO₂ cooperatively at pressures relevant to purification at natural gas wellheads. These materials offer significant advantages in a pressure-swing adsorption (PSA) process as compared to other solid sorbents by: (1) allowing regeneration at or near atmospheric pressure, (2) minimizing thermal energy requirements for regeneration, and (3) exhibiting stability and selectivity in the presence of humidity.

The disclosure provides a diamine-appended metal-organic framework (MOF) comprising a repeating core having the general structure

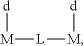

wherein M is a metal or metal ion, d is a diamine appendage comprising a tertiary amine and wherein the diamine appendage is connected to M via a coordinate bond, and L is a linking moiety comprising a structure of Formula I, II and/or Formula III:

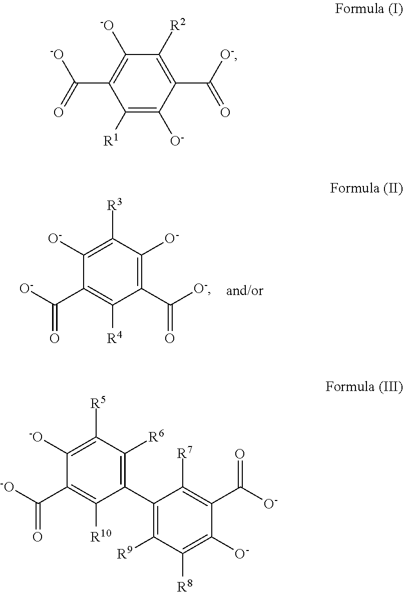

wherein, R¹-R¹⁰ are independently selected from H, D, FG, optionally substituted (C₁-C₁₂) alkyl, optionally substituted hetero-(C₁-C₁₂)alkyl, optionally substituted (C₁-C₁₂)alkenyl, optionally substituted hetero-(C₁-C₁₂)alkenyl, optionally substituted (C₁-C₁₂)alkynyl, optionally substituted hetero-(C₁-C₁₂)alkynyl, optionally substituted (C₁-C₁₂)cycloalkyl, optionally substituted (C₁-C₁₂)cycloalkenyl, optionally substituted aryl, optionally substituted heterocycle, optionally substituted mixed ring system, —C(R¹¹)₃, —CH(R¹¹)₂, —CH₂R¹¹, —C(R¹²)₃, —CH(R¹²)₂, —CH₂R¹², —OC(R¹¹)₃, OCH(R¹¹)₂, —OCH₃R¹¹, —OC(R¹²)₃, —OCH(R¹²)₂, OCH₂R¹²; R¹¹ is selected from FG, optionally substituted (C₁-C₁₂)alkyl, optionally substituted hetero-(C₁-C₁₂) alkyl, optionally substituted (C₁-C₁₂) alkenyl, optionally substituted hetero-(C₁-C₁₂) alkenyl, optionally substituted (C₁-C₁₂)alkynyl, optionally substituted hetero-(C₁-C₁₂)alkynyl, hemiacetal, hemiketal, acetal, ketal, and orthoester; and R¹² is selected from one or more substituted or unsubstituted rings selected from cycloalkyl, aryl and heterocycle. In one embodiment, the L is a linking moiety comprising a structure of Formula I, II and/or Formula III:

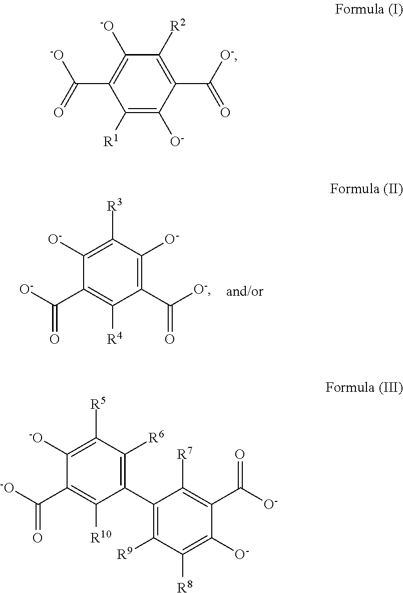

wherein, R¹-R¹⁰ are independently selected from H, halo, amino, amide, imine, azide, methyl, cyano, nitro, nitroso, hydroxyl, aldehyde, carbonyl, ester, thiol, sulfinyl, sulfonyl, and thiocyanate. In yet another embodiment of any of the foregoing the L is a linking moiety comprising the structure of Formula (III):

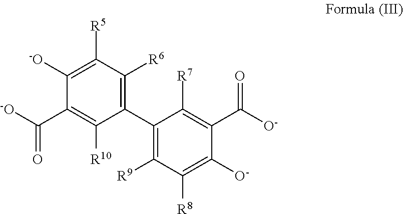

wherein, R⁵-R¹⁰ are H. In yet another embodiment of any of the foregoing d comprises the structure of Compound I:

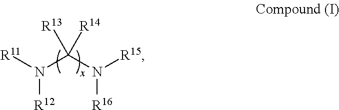

wherein, R¹¹-R¹² are each independently selected from H, D, an optionally substituted (C₁-C₃)alkyl, an optionally substituted (C₂-C₃)alkenyl, —C(═O)CH₃, and hydroxyl, wherein at least 1 of R¹¹-R¹² are an H; R¹³-R¹⁴ are each independently selected from H, D, FG, an optionally substituted (C₁-C₆)alkyl, an optionally substituted hetero-(C₁-C₆)alkyl, an optionally substituted (C₂-C₃)alkenyl, an optionally substituted hetero(C₂-C₃)alkenyl, an optionally substituted (C₂-C₆)alkynyl, an optionally substituted hetero(C₂-C₆)alkynyl, cycloalkyl, aryl, and heterocycle; R¹⁵-R¹⁶ are each independently an FG, an optionally substituted (C₁-C₆)alkyl, an optionally substituted hetero-(C₁-C₆)alkyl, an optionally substituted (C₂-C₃)alkenyl, an optionally substituted hetero(C₂-C₃)alkenyl, an optionally substituted (C₂-C₆)alkynyl, an optionally substituted hetero(C₂-C₆)alkynyl, cycloalkyl, aryl, and heterocycle, and x is an integer from 1 to 6. In a further embodiment, d comprises the structure of Compound I(a):

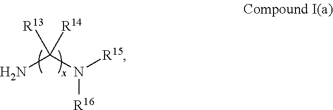

wherein, R¹³-R¹⁴ are each independently selected from H, D, an optionally substituted (C₁-C₆)alkyl, and an optionally substituted hetero-(C₁-C₆) alkyl; R¹⁵-R¹⁶ are each independently an optionally substituted (C₁-C₃)alkyl or an optionally substituted hetero-(C₁-C₃)alkyl; and x is an integer from 1 to 6. In yet another embodiment of the diamine-appended MOF, d is selected from the group consisting of 1,2-diaminopropane, N,N-diethylethylenediamine, 2-(diisopropylamino) ethylamine, N,N′-dimethyl ethylenediamine, N-propylethylenediamine, N-butyl ethylenediamine, N,N-dimethyl-N′-ethylethylenediamine, 1,2-diaminocyclohexane, diethylenetriamine, N-(2-aminoethyl)-1,3-propanediamine, N-isopropyl diethylenetriamine, triethylenetetramine, tris(2-aminoethyl) amine, piperazine, 1-(2-aminoethyl) piperazine, N,N,N′,N′-tetramethyldiamino methane, N,N,N′-trimethylethylenediamine, 3-(dimethylamino)-1-propylamine, 4-(2-aminoethyl)morpholine, N-(2-hydroxyethyl)ethylenediamine; N,N-diethylethylenetriamine, N,N-diisopropylethylenediamine; N,N,N′-trimethylethylenediamine, 1-(2-aminoethyl)-pyrrolidine; 1-(2-aminoethyl)piperidine, and N-(2-hydroxyethyl)ethylenediamine. In a further embodiment, d is N,N-diethylethylenediamine or N,N-diisopropylethylenediamine. In still another embodiment of any of the foregoing embodiments, M is selected from Be²⁺, Mg²⁺, Ca²⁺, Sr²⁺, Ba²⁺, Sc²⁺, Y²⁺, Ti²⁺, Zr+, V²⁺, Nb⁺, Ta²⁺, Cr²⁺, Mo²⁺, W²⁺, Mn²⁺, Re²⁺, Fe²⁺, Ru²⁺, Os⁺, Co⁺, Rh²⁺, Ir⁺, Ni²⁺, Pd²⁺, Pt²⁺, Cu²⁺, Ag⁺, Au⁺, Zn²⁺, Cd²⁺, Hg²⁺, B²⁺, Al²⁺, Ga²⁺, In⁺, Si²⁺, Ge²⁺, Sn²⁺, Pb²⁺, As²⁺, Te²⁺, La⁺, Ce²⁺, Pr²⁺, Nd²⁺, Sm²⁺, Eu²⁺, Gd²⁺, Tb²⁺, Db²⁺, Tm²⁺, Cs²⁺, Yb²⁺, and La²⁺, including any complexes which contain the metal ions, as well as any corresponding metal salt counter-anions. In a further embodiment, M is selected from the group consisting of Mg²⁺, Ca²⁺, Ba²⁺, Zr⁺, V²⁺, Mn²⁺, Fe²⁺, Co²⁺, Ni²⁺, Cu⁺, Zn²⁺, and Cd²⁺. In still a further embodiment, M is Mg²⁺. In yet another embodiment of any of the foregoing embodiments, the diamine-appended MOF is capable of cooperative insertion of CO₂ at a pressure above 1 bar and at a temperature from 30° C. to 80° C. In still another embodiment of any of the foregoing, the diamine-appended MOF is reacted with a post framework reactant that adds at least one effect to the diamine-appended MOF selected from modulating the acid gas storage and/or separation ability of the MOF; modulating the sorption properties of the MOF; and modulating the pore size of the MOF.

The disclosure also provides a device comprising the diamine-appended MOF of the disclosure. In one embodiment, the device is an acid gas separation and/or acid gas storage device. In another embodiment, the device comprises the diamine-appended MOF as an acid gas adsorbent. In yet another embodiment, the device is used with fuel gas. In still another embodiment, the device is used to separate CO₂ from natural gas. In still another embodiment of any of the foregoing embodiments, the device is a membrane or filter device. In a further embodiment, the device is a pressure swing device or a temperature swing device.

The disclosure also provides a method of separating and/or storing one or more acid gases from a fuel gas comprising contacting the fuel gas with a diamine-appended MOF of device comprising a diamine-appended MOF as described herein. In one embodiment, the fuel gas is natural gas. In another embodiment, the one or more acid gases is CO₂.

The disclosure also provides a process for purifying a stream of natural gas comprising, passing an influent stream of natural gas through a device or material comprising a diamine-appended MOF disclosed herein, wherein the effluent stream comprises less CO₂ than the natural gas influent stream. In one embodiment, the device is a pressure swing device or a temperature swing device.

The disclosure also provides an adsorbent material, comprising a porous metal-organic framework a diamine with a general molecular formula of NH₂CH₂CH₂NR₂, where —R represents an organic group from selection of —CH₃, CH₂CH₃, CH₂CH₂CH₃, or —CHCH₃CH₃ wherein the diamine-appended metal-organic framework is prepared as a shaped particle, extrudate or pellet wherein the selection of the diamine is chosen to selectively adsorb CO₂ from a feed gas stream of natural gas including acid gas, water, and methane, ranging in feed pressures from about 50 psia to about 1000 psia with a CO₂ mole fraction from about 5 mol % to about 50 mol %. In one embodiment, the acid gas is a gas selected from the group consisting of carbon dioxide, hydrogen sulfide, carbonyl sulfide, combinations thereof, and combinations thereof with water.

The disclosure also provides an adsorbent pellet material prepared by combination of a porous metal-organic framework, a diamine with a general molecular formula of NH₂CH₂CH₂NR₂, where —R represents an organic group from selection of —CH₃, CH₂CH₃, CH₂CH₂CH₃, or —CHCH₃CH₃, wherein solvents including toluene and hexanes are occluded in the pores of the adsorbent wherein the powdered material containing solvents is pressed into a shaped particle, extrudate or pellet to produce an adsorbent particle, extrudate or pellet.

The disclosure also provides a method for removing acid gas from a feed gas stream of natural gas including acid gas, water, and methane, comprising alternating input of the feed gas stream between at least two beds of adsorbent particles comprising a diamine-appended metal-organic framework such that the feed gas stream contacts one of the at least two beds at a given time in an adsorption step and a tail gas stream is simultaneously vented from another of the at least two beds in a desorption step; wherein the contact occurs at a feed pressure of from about 50 to about 1000 psia for a sufficient period of time to preferentially adsorb acid gas from the feed gas stream; thereby producing a product gas stream containing no greater than about 2 mol % carbon; and wherein the feed gas stream is input at a feed end of each bed; the product gas stream is removed from a product end of each bed; and the tail gas stream is vented from the feed end of each bed. In one embodiment, the at least two beds of adsorbent particles comprising a diamine-appended metal-organic framework are four beds of adsorbent particles comprising a diamine-appended metal-organic framework; and wherein the product gas stream contains at least about 80 mol % of methane recovered from the feed gas stream. In one embodiment, the acid gas adsorbed from the feed gas stream comprises carbon dioxide and from 0 to 1000 ppm hydrogen sulfide. In another embodiment, the feed gas stream has a flow rate of from 1 to 100 MMSCFD in the adsorption step and the adsorption step occurs at a temperature of from 20 to 80° C. In still another embodiment, the product gas stream contains no greater than about 50 ppm hydrogen sulfide. In another embodiment, the product gas stream contains no greater than about 4 ppm hydrogen sulfide. In yet another embodiment, the acid gas is a gas selected from the group consisting of carbon dioxide, hydrogen sulfide, carbonyl sulfide, combinations thereof, and combinations thereof with water. In still another embodiment, the method utilizes two beds of adsorbent particles comprising diamine-appended metal-organic framework and further comprising following the adsorption step in one of the two beds and simultaneous desorption step in the other of the two beds, equalizing pressure of the two beds through the product end of each of the two beds at the end of the adsorption step and simultaneous desorption step; and repressurizing the bed having just completed the desorption step by sending a slipstream of the product gas stream through the product end of the bed having just completed the desorption step. In another embodiment, the method is performed on an offshore platform.

The disclosure also provides a method for removing acid gas from a feed gas stream of natural gas including methane, carbon dioxide and from 4 to 1000 ppm hydrogen sulfide, comprising alternating input of the feed gas stream between at least two beds of adsorbent particles comprising diamine-appended metal-organic framework such that the feed gas stream contacts one of the at least two beds at a given time in an adsorption step and a tail gas stream is simultaneously vented from another of the at least two beds in a desorption step; wherein the contact occurs at a feed pressure of from about 50 to about 1000 psia for a sufficient period of time to preferentially adsorb acid gas from the feed gas stream; thereby producing a product gas stream containing no greater than about 2 mol % carbon dioxide, no greater than about 1 ppm H₂S, no greater than about 1 ppm COS, and at least about 65 mol % of methane recovered from the feed gas stream; and wherein the feed gas stream is input at a feed end of each bed; the product gas stream is removed from a product end of each bed; and the tail gas stream is vented from the feed end of each bed.

### DESCRIPTION OF DRAWINGS

FIG. 1 presents an example of single pore of a one-dimensional, hexagonal channel of a diamine-appended MOF of the disclosure. A 4,4′-dioxido-3,3′-biphenyldicarboxylate (dopdc⁴⁻) linking ligand and nitrogen containing compounds: N,N-diisopropylethylenediamine (ii-2) and N,N-diethylethylenediamine (ee-2) are also presented.

FIG. 2 shows X-ray powder diffraction patterns of Mg—₂(dobpdc) (black, top), ee-2-Mg₂(dobpdc) (dark grey, middle), and ii-2-Mg₂ (dobpdc) (light grey, bottom).

FIG. 3 shows a schematic process used to form pellets from powdered adsorbent.

FIG. 4 shows thermogravimetric analysis of ii-2-Mg₂(dobpdc) under He at a ramp rate of 2° C./min. Initial weight loss is due to residual hexanes in the pores. Normalized weight loss between the first two plateaus corresponds to 97% occupancy of diamine per metal site.

FIG. 5 shows thermogravimetric analysis of ee-2-Mg₂(dobpdc) under N₂ at a ramp rate of 2° C./min. Initial weight loss is due to residual hexanes in the pores. Normalized weight loss between the first two plateaus corresponds to 97% coverage of diamine per metal site.

FIG. 6 shows N₂ adsorption isotherms at 77 K for ee-2-Mg₂(dobpdc) (circles) and ii-2-Mg₂(dobpdc) (squares), used to calculate Langmuir surface areas of 802 and 491 m²/g, respectively. As expected, grafting of diamines onto the metal sites lining the pores of the structure significantly reduced the accessible pore volume from that of the bare Mg₂(dobpdc) framework, which was found to have a Langmuir surface area of 4086 m²/g.

FIG. 7A-D adsorption curves for ee-2-Mg₂(dobpdc) and ii-2-Mg₂ (dobpdc). (A) Shows high-pressure CO₂ (circles), CH₄ (squares) N₂ (triangle), and H₂ (diamonds) adsorption isotherms for ii-2-Mg₂(dobpdc) at 25° C. (light grey), 40° C. (dark grey), and 50° C. (black). All high-pressure isotherms for this material have been converted from excess to total adsorption using the experimental pore volume of 0.169 cm³/g determined from the N₂ adsorption isotherm at 77 K. The onset of cooperative CO₂ adsorption was observed at 0.5 bar, 1 bar, and 1.5 bar respectively for the 25° C., 40° C., and 50° C. isotherms. (B) Shows high-pressure, single-component isotherms for ee-2-Mg₂(dobpdc) with CO₂ (circles; filled, adsorption; open, desorption) and CH₄ (squares) at 25, 40, 50, and 75° C. (light to dark). (C) Shows H₂O adsorption (filled symbols) and desorption (open symbols) isotherms for ee-2-Mg₂(dobpdc) powder (circles) and 60-80 mesh pellets (triangles) at 25° C. (light grey), 30° C. (dark grey), and 50° C. (black). (D) Shows low-pressure CO₂ adsorption isotherms at 30° C. for ee-2-Mg₂(dobpdc) powder (circles) and 60-80 mesh pellets (triangles) for the as-synthesized material (light grey), the same sample after saturation with H₂O and evacuation at 30° C. (dark grey), and the same sample after evacuation at 100° C.

FIG. 8A-F shows (A) Single-component CO₂ adsorption isotherms for ii-2-Mg₂(dobpdc) from 0 to 11 bar at 25° C. (light grey), 40° C. (dark grey), and 50° C. (black). (B) Single-component CO₂ adsorption isotherms for ee-2-Mg₂(dobpdc) from 0 to 1.2 bar at 25° C. (circles), 40° C. (upward triangles), 50° C. (diamonds), 75° C. (downward triangles), 100° C. (pluses), and 120° C. (crosses). (C) A comparison of single-component isotherms for CO₂ absorption versus CH₄ absorption for ii-2-Mg2(dobpdc) (D), ee-2-Mg2(dobpdc) (E), and zeolite 13X (F) at increasing pressure.

FIG. 9 shows TGA cycling of ee-2-Mg₂(dobpdc) with CO₂/CH₄ (black) and CO₂/CH₄/H₂O (grey) following activation under N₂.

FIG. 10 shows dynamic column breakthrough apparatus for multicomponent adsorption testing.

FIG. 11 shows dynamic breakthrough profile of ii-2-Mg₂(dopbdc) at 70 bar and 30° C. in 10 mol % CO₂ and 90 mol % CH₄.

FIG. 12 shows dynamic breakthrough profile of ee-2-Mg₂(dopbdc) at 70 bar and 30° C. in 10 mol % CO₂ and 90 mol % CH₄.

FIG. 13 shows dynamic CO₂ breakthrough profile of ii-2-Mg₂(dopbdc) at varying feed pressure and 30° C. in 10 mol % CO₂ and 90 mol % CH₄.

FIG. 14 shows dynamic breakthrough profiles of zeolite 13X at 7 bar and 30° C. in 10 mol % CO₂ and 90 mol % CH₄ under 55% relative humidity. Solid lines show cycle 1; dashed lines, cycle 2.

FIG. 15 shows dynamic breakthrough profiles of ee-2-Mg₂(dobpdc) at 7 bar and 30° C. in 10 mol % CO₂ and 90 mol % CH₄ under 55% relative humidity. Solid lines show cycle 1; dashed lines, cycle 2.

FIG. 16 shows dynamic breakthrough profiles of ee-2-Mg₂(dobpdc) at 50 bar and 30° C. in 10 mol % CO₂ and 90 mol % CH₄.

FIG. 17 shows dynamic breakthrough profiles of ee-2-Mg₂(dobpdc) at 50 bar and 30° C. in 10 mol % CO₂ and 90 mol % CH₄ following pre-saturation of the bed with H₂O.

FIG. 18 shows thermogravimetric cooling curves at atmospheric pressure showing adsorption of ee-2-Mg₂(dobpdc) under wet CO₂ (dotted line), dry CO₂ (dashed line), and wet N₂ (solid line) with a cooling rate of 2° C./min. Adsorption of CO₂ at a higher temperature under wet conditions in this isobaric, thermogravimetric experiment is analogous to adsorption at a lower partial pressure in an isothermal, volumetric experiment.

FIG. 19A-B shows Dynamic scanning calorimetry (DSC) exotherms observed for (A) ee-2-Mg2(dobpdc) and (B) ii-2-Mg2(dobpdc) at atmospheric pressure upon exposure to flowing CO₂ at the specified temperature following activation with flowing He at 100° C. In each case, the exotherm can be seen to broaden and flatten as the step moves above 1 bar (75° C. for ee-2-Mg2(dobpdc); 40° C. for ii-2-Mg2(dobpdc)). At all temperatures, significantly faster adsorption was observed for the ee-2 material as compared to the ii-2 material.

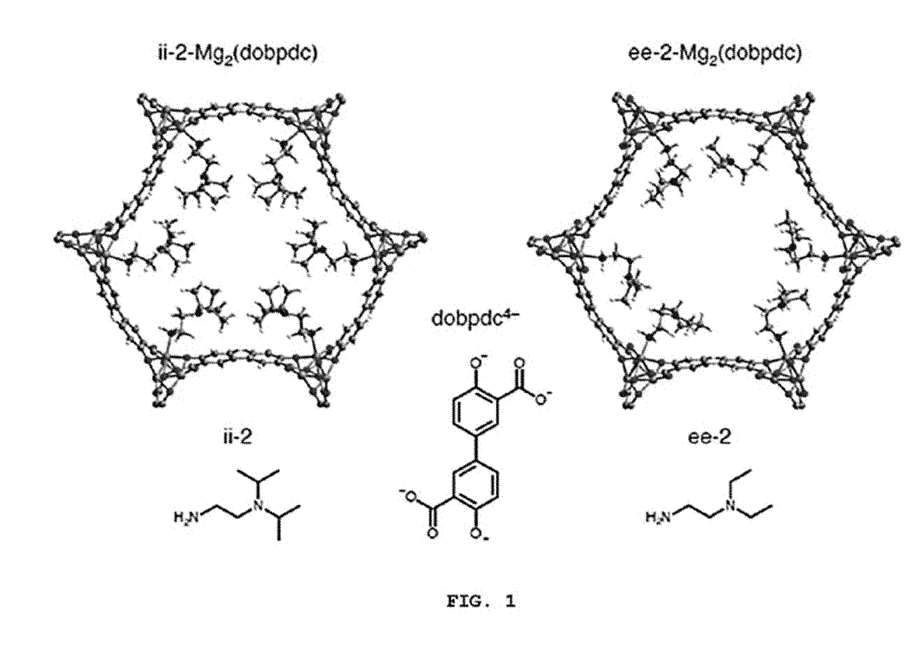

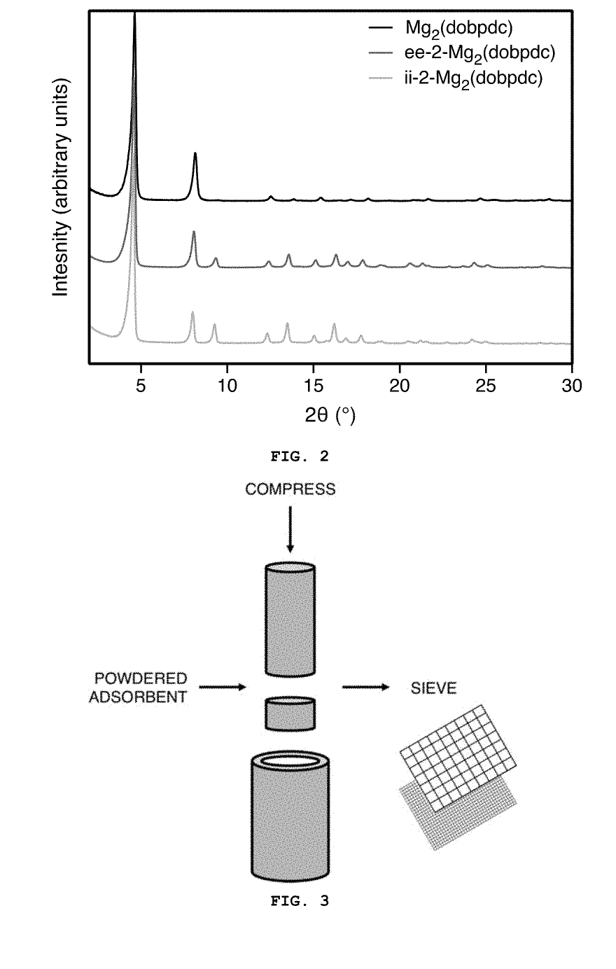

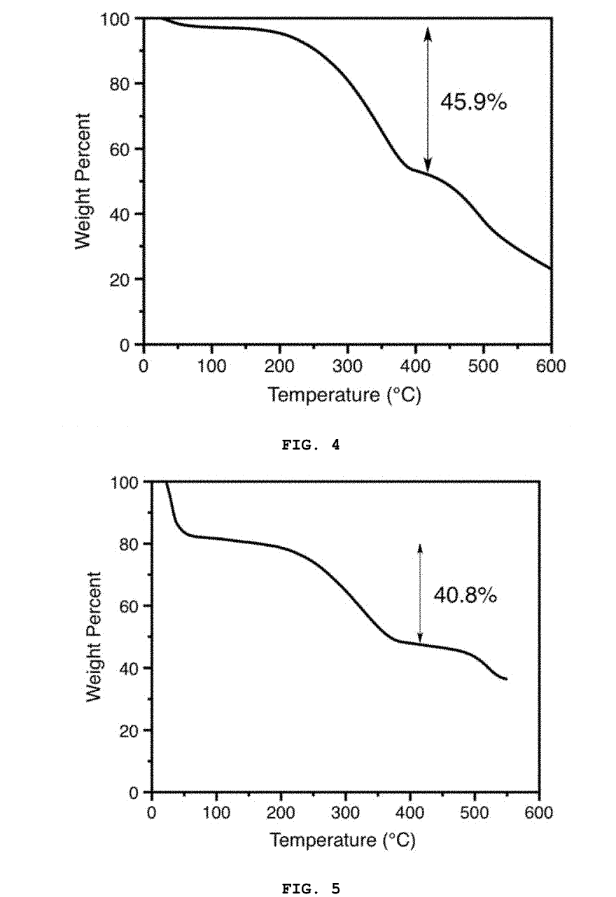

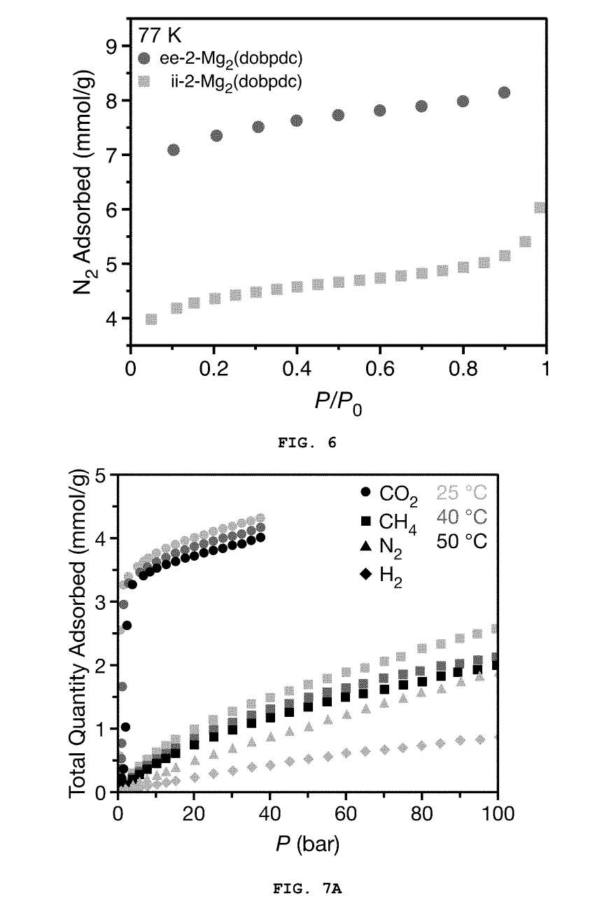

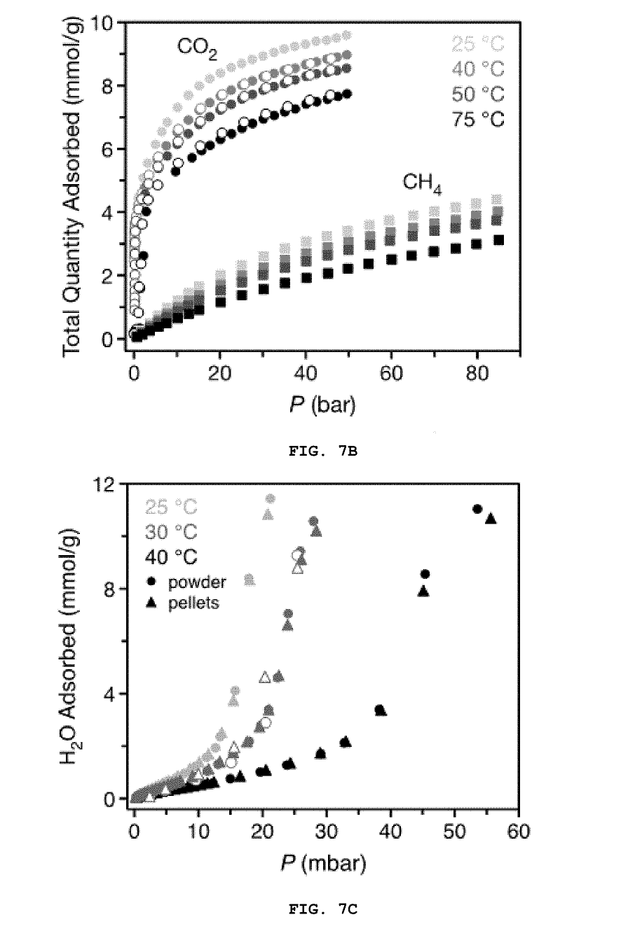

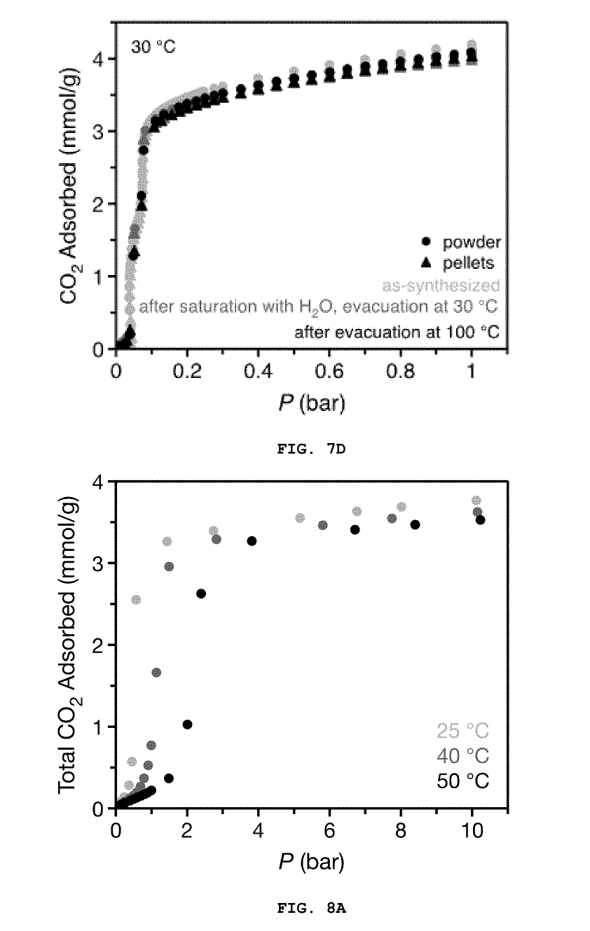

### DETAILED DESCRIPTION

As used herein and in the appended claims, the singular forms “a,” “an,” and “the” include plural referents unless the context clearly dictates otherwise. Thus, for example, reference to “an organic linking ligand” includes a plurality of such linking ligands and reference to “the metal ion” includes reference to one or more metal ions and equivalents thereof known to those skilled in the art, and so forth.

Unless defined otherwise, all technical and scientific terms used herein have the same meaning as commonly understood to one of ordinary skill in the art. Although there are many methods and reagents similar or equivalent to those described herein, the exemplary methods and materials are presented herein.

Also, the use of “or” means “and/or” unless indicated otherwise, such as by the use of the term “either.” Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications mentioned herein are incorporated by reference in full for the purpose of describing and disclosing methodologies that might be used in connection with the description herein. Moreover, with respect to any term that is presented in the publications that is similar to, or identical with, a term that has been expressly defined in this disclosure, the definition of the term as expressly provided in this disclosure will control in all respects.

The term “alkenyl”, refers to an organic group that is comprised of carbon and hydrogen atoms that contains at least one double covalent bond between two carbons. Typically, an “alkenyl” as used in this disclosure, refers to organic group that contains 1 to 30 carbon atoms, unless stated otherwise. While a C₁-alkenyl can form a double bond to a carbon of a parent chain, an alkenyl group of three or more carbons can contain more than one double bond. It certain instances the alkenyl group will be conjugated, in other cases an alkenyl group will not be conjugated, and yet other cases the alkenyl group may have stretches of conjugation and stretches of nonconjugation. Additionally, if there is more than 1 carbon, the carbons may be connected in a linear manner, or alternatively if there are more than 3 carbons then the carbons may also be linked in a branched fashion so that the parent chain contains one or more secondary, tertiary, or quaternary carbons. An alkenyl may be substituted or unsubstituted, unless stated otherwise.

The term “alkyl”, refers to an organic group that is comprised of carbon and hydrogen atoms that contain single covalent bonds between carbons. Typically, an “alkyl” as used in this disclosure, refers to an organic group that contains 1 to 30 carbon atoms, unless stated otherwise. Where if there is more than 1 carbon, the carbons may be connected in a linear manner, or alternatively if there are more than 2 carbons then the carbons may also be linked in a branched fashion so that the parent chain contains one or more secondary, tertiary, or quaternary carbons. An alkyl may be substituted or unsubstituted, unless stated otherwise.

The term “alkynyl”, refers to an organic group that is comprised of carbon and hydrogen atoms that contains a triple covalent bond between two carbons. Typically, an “alkynyl” as used in this disclosure, refers to organic group that contains 1 to 30 carbon atoms, unless stated otherwise. While a C₁-alkynyl can form a triple bond to a carbon of a parent chain, an alkynyl group of three or more carbons can contain more than one triple bond. Where if there is more than 1 carbon, the carbons may be connected in a linear manner, or alternatively if there are more than 4 carbons then the carbons may also be linked in a branched fashion so that the parent chain contains one or more secondary, tertiary, or quaternary carbons. An alkynyl may be substituted or unsubstituted, unless stated otherwise.

The term “aryl”, as used in this disclosure, refers to a conjugated planar ring system with delocalized pi electron clouds that contain only carbon as ring atoms. An “aryl” for the purposes of this disclosure encompass from 1 to 12 aryl rings wherein when the aryl is greater than 1 ring the aryl rings are joined so that they are linked, fused, or a combination thereof. An aryl may be substituted or unsubstituted, or in the case of more than one aryl ring, one or more rings may be unsubstituted, one or more rings may be substituted, or a combination thereof. Examples of aryls, include but are not limited to, phenyl and napthylene, and anthracene.

The term “cylcloalkenyl”, as used in this disclosure, refers to an alkene that contains at least 3 carbon atoms but no more than 12 carbon atoms connected so that it forms a ring. A “cycloalkenyl” for the purposes of this disclosure encompass from 1 to 12 cycloalkenyl rings, wherein when the cycloalkenyl is greater than 1 ring, then the cycloalkenyl rings are joined so that they are linked, fused, or a combination thereof. A cycloalkenyl may be substituted or unsubstituted, or in the case of more than one cycloalkenyl ring, one or more rings may be unsubstituted, one or more rings may be substituted, or a combination thereof.

The term “cylcloalkyl”, as used in this disclosure, refers to an alkyl that contains at least 3 carbon atoms but no more than 12 carbon atoms connected so that it forms a ring. A “cycloalkyl” for the purposes of this disclosure encompass from 1 to 12 cycloalkyl rings, wherein when the cycloalkyl is greater than 1 ring, then the cycloalkyl rings are joined so that they are linked, fused, or a combination thereof. A cycloalkyl may be substituted or unsubstituted, or in the case of more than one cycloalkyl ring, one or more rings may be unsubstituted, one or more rings may be substituted, or a combination thereof.

The term “framework” as used herein, refers to a highly ordered structure comprised of secondary building units (SBUs) that can be linked together in defined, repeated and controllable manner, such that the resulting structure is characterized as being porous, periodic and crystalline. Typically, “frameworks” are two dimensional (2D) or three dimensional (3D) structures. Examples of “frameworks” include, but are not limited to, “metal-organic frameworks” or “MOFs”, “zeolitic imidazolate frameworks” or “ZIFs”, or “covalent organic frameworks” or “COFs”. While MOFs and ZIFs comprise SBUs of metals or metal ions linked together by forming covalent bonds with linking clusters on organic linking moieties, COFs are comprised of SBUs of organic linking moieties that are linked together by forming covalent bonds via linking clusters. As used herein, “framework” does not refer to coordination complexes or metal complexes. Coordination complexes or metal complexes are comprised of a relatively few number of centrally coordinated metal ions (i.e., less than 4 central ions) that are coordinately bonded to molecules or ions, also known as ligands or complexing agents. By contrast, “frameworks” are highly ordered and extended structures that are not based upon a centrally coordinated ion, but involve many repeated secondary building units (SBUs) linked together (e.g., >10, >100, >1000, >10,000, etc). Accordingly, “frameworks” are orders of magnitude much larger than coordination complexes and have different structural and chemical properties due to the framework's open and ordered structure.

The term “functional group” or “FG” refers to specific groups of atoms within molecules that are responsible for the characteristic chemical reactions of those molecules. While the same functional group will undergo the same or similar chemical reaction(s) regardless of the size of the molecule it is a part of, its relative reactivity can be modified by nearby functional groups. The atoms of functional groups are linked to each other and to the rest of the molecule by covalent bonds. Examples of FGs that can be used in this disclosure, include, but are not limited to, substituted or unsubstituted alkyls, substituted or unsubstituted alkenyls, substituted or unsubstituted alkynyls, substituted or unsubstituted aryls, substituted or unsubstituted hetero-alkyls, substituted or unsubstituted hetero-alkenyls, substituted or unsubstituted hetero-alkynyls, substituted or unsubstituted cycloalkyls, substituted or unsubstituted cycloalkenyls, substituted or unsubstituted hetero-aryls, substituted or unsubstituted heterocycles, halos, hydroxyls, anhydrides, carbonyls, carboxyls, carbonates, carboxylates, aldehydes, haloformyls, esters, hydroperoxy, peroxy, ethers, orthoesters, carboxamides, amines, amides, imines, imides, azides, azos, cyanates, isocyanates, nitrates, nitriles, isonitriles, nitrosos, nitros, nitrosooxy, pyridyls, sulfhydryls, sulfides, disulfides, sulfinyls, sulfos, thiocyanates, isothiocyanates, carbonothioyls, phosphinos, phosphonos, phosphates, Si(OH)₃, Ge(OH)₃, Sn(OH)₃, Si(SH)₄, Ge(SH)₄, AsO₃H, AsO₄H, P(SH)₃, As(SH)₃, SO₃H, Si(OH)₃, Ge(OH)₃, Sn(OH)₃, Si(SH)₄, Ge(SH)₄, Sn(SH)₄, AsO₃H, AsO₄H, P(SH)₃, and As(SH)₃. In a particular embodiment, a functional group refers to halos, hydroxyls, carboxyls, carbonates, carboxylates, aldehydes, esters, ethers, amines, amides, azides, nitriles, sulfides, and nitros.

The term “heterocycle”, as used in this disclosure, refers to ring structures that contain at least 1 noncarbon ring atom. A “heterocycle” for the purposes of this disclosure encompass from 1 to 12 heterocycle rings wherein when the heterocycle is greater than 1 ring the heterocycle rings are joined so that they are linked, fused, or a combination thereof. A heterocycle may be a hetero-aryl or nonaromatic, or in the case of more than one heterocycle ring, one or more rings may be nonaromatic, one or more rings may be hetero-aryls, or a combination thereof. A heterocycle may be substituted or unsubstituted, or in the case of more than one heterocycle ring one or more rings may be unsubstituted, one or more rings may be substituted, or a combination thereof. Typically, the noncarbon ring atom is N, O, S, Si, Al, B, or P. In case where there is more than one noncarbon ring atom, these noncarbon ring atoms can either be the same element, or combination of different elements, such as N and O. Examples of heterocycles include, but are not limited to: a monocyclic heterocycle such as, aziridine, oxirane, thiirane, azetidine, oxetane, thietane, pyrrolidine, pyrroline, imidazolidine, pyrazolidine, pyrazoline, dioxolane, sulfolane 2,3-dihydrofuran, 2,5-dihydrofuran tetrahydrofuran, thiophane, piperidine, 1,2,3,6-tetrahydro-pyridine, piperazine, morpholine, thiomorpholine, pyran, thiopyran, 2,3-dihydropyran, tetrahydropyran, 1,4-dihydropyridine, 1,4-dioxane, 1,3-dioxane, dioxane, homopiperidine, 2,3,4,7-tetrahydro-1H-azepine homopiperazine, 1,3-dioxepane, 4,7-dihydro-1,3-dioxepin, and hexamethylene oxide; and polycyclic heterocycles such as, indole, indoline, isoindoline, quinoline, tetrahydroquinoline, isoquinoline, tetrahydroisoquinoline, 1,4-benzodioxan, coumarin, dihydrocoumarin, benzofuran, 2,3-dihydrobenzofuran, isobenzofuran, chromene, chroman, isochroman, xanthene, phenoxathiin, thianthrene, indolizine, isoindole, indazole, purine, phthalazine, naphthyridine, quinoxaline, quinazoline, cinnoline, pteridine, phenanthridine, perimidine, phenanthroline, phenazine, phenothiazine, phenoxazine, 1,2-benzisoxazole, benzothiophene, benzoxazole, benzthiazole, benzimidazole, benztriazole, thioxanthine, carbazole, carboline, acridine, pyrolizidine, and quinolizidine. In addition to the polycyclic heterocycles described above, heterocycle includes polycyclic heterocycles wherein the ring fusion between two or more rings includes more than one bond common to both rings and more than two atoms common to both rings. Examples of such bridged heterocycles include quinuclidine, diazabicyclo[2.2.1]heptane and 7-oxabicyclo[2.2.1]heptane.

The terms “heterocyclic group”, “heterocyclic moiety”, “heterocyclic”, or “heterocyclo” used alone or as a suffix or prefix, refers to a heterocycle that has had one or more hydrogens removed therefrom.

The term “hetero-” when used as a prefix, such as, hetero-alkyl, hetero-alkenyl, hetero-alkynyl, or hetero-hydrocarbon, for the purpose of this disclosure refers to the specified hydrocarbon having one or more carbon atoms replaced by non-carbon atoms as part of the parent chain. Examples of such non-carbon atoms include, but are not limited to, N, O, S, Si, Al, B, and P. If there is more than one non-carbon atom in the hetero-based parent chain then this atom may be the same element or may be a combination of different elements, such as N and O.

The term “hydrocarbons” refers to groups of atoms that contain only carbon and hydrogen. Examples of hydrocarbons that can be used in this disclosure include, but are not limited to, alkanes, alkenes, alkynes, arenes, and benzyls. In a particular embodiment, the hydrocarbon is an aromatic hydrocarbon.

The term “mixed ring system” refers to optionally substituted ring structures that contain at least two rings, and wherein the rings are joined together by linking, fusing, or a combination thereof. A mixed ring system comprises a combination of different ring types, including cycloalkyl, cycloalkenyl, aryl, and heterocycle.

The term “substituted” with respect to hydrocarbons, heterocycles, and the like, refers to structures wherein the parent chain contains one or more substituents.

The term “substituent” refers to an atom or group of atoms substituted in place of a hydrogen atom. For purposes of this disclosure, a substituent would include deuterium atoms.

The term “unsubstituted” with respect to hydrocarbons, heterocycles, and the like, refers to structures wherein the parent chain contains no substituents.

The continued growth of natural gas as a cleaner-burning alternative to coal provides strong motivation to seek improved, energy-efficient strategies for purification of crude reserves. Acid gases such as carbon dioxide are among the most common impurities, frequently present at concentrations of 5-20 mol %. In order to deliver these reserves to the pipeline, the CO₂ concentration must be reduced to a maximum of 2 mol %. Traditionally, this purification has been achieved with aqueous amine absorbers. However, the high heat capacity of water generates a large energy penalty during thermal regeneration of the absorber units. While solid sorbent-based technology has advanced significantly in recent years, many zeolite and activated carbon adsorbents sacrifice CH₄ recovery or purity at the wellhead conditions, typically 30-80° C. and 70 bar. Further, these adsorbents often suffer drastic reductions in selectivity for CO₂ in the presence of humidity.

Metal-organic frameworks (MOFs) are porous crystalline materials that are constructed by the linkage of inorganic metal clusters called secondary building units (SBUs) with organic linkers. These materials have very large surface areas and pore volumes. Therefore, MOFs are ideally suited for use in gas sorption and/or gas separation. MOFs have been shown to have tremendous utility in the separation of various hydrocarbon mixtures, including ethane/ethylene, propane/propylene, and Cs alkane mixtures, among many others.

Metal-organic frameworks featuring cooperative adsorption of CO₂ have recently been demonstrated as promising adsorbents for highly selective CO₂ capture in the presence of water. As a notable example, post-synthetic grafting of N,N′-dimethylethylenediamine (mmen) to the coordinatively unsaturated metal sites lining the pores of the framework M₂(dobpdc) (M=Mg, Mn, Fe, Co, Ni, Zn) yielded materials with unusual CO₂ isotherms featuring sharp, step-like adsorption. X-ray diffraction and spectroscopic investigation of this adsorption mechanism revealed that selective and cooperative binding of CO₂ in these materials proceeds by insertion of CO₂ into the metal-diamine bonds of the framework, forming chains of ammonium carbamate.

By using an adsorbent exhibiting cooperative CO₂ adsorption with a threshold pressure slightly greater than 1 bar, the full working capacity of a MOF material having reactive amines could be achieved simply by dropping the pressure of a CO₂-saturated bed from the feed condition of ˜70 bar to atmospheric pressure. In contrast to aqueous amine or competing solid sorbent systems, a separation unit with an adsorbent of this nature would not require significant heating or vacuum for regeneration.

Due to the high thermal stability, low toxicity, ease of scalability, and low cost of the base Mg₂(dobpdc) framework, magnesium variants of the M₂(dobpdc) (diamine)₂ class of adsorbents are the most appealing for a cooperative adsorptive separation of CO₂. However, no reported material of this class has yet demonstrated cooperative insertion of CO₂ at a pressure above 1 bar for temperatures relevant to natural gas purification (30-80° C.).

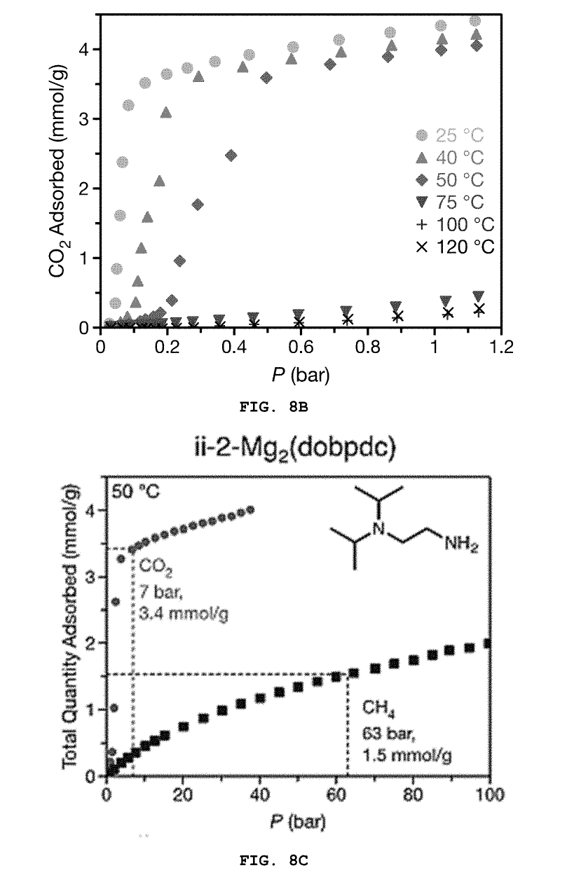

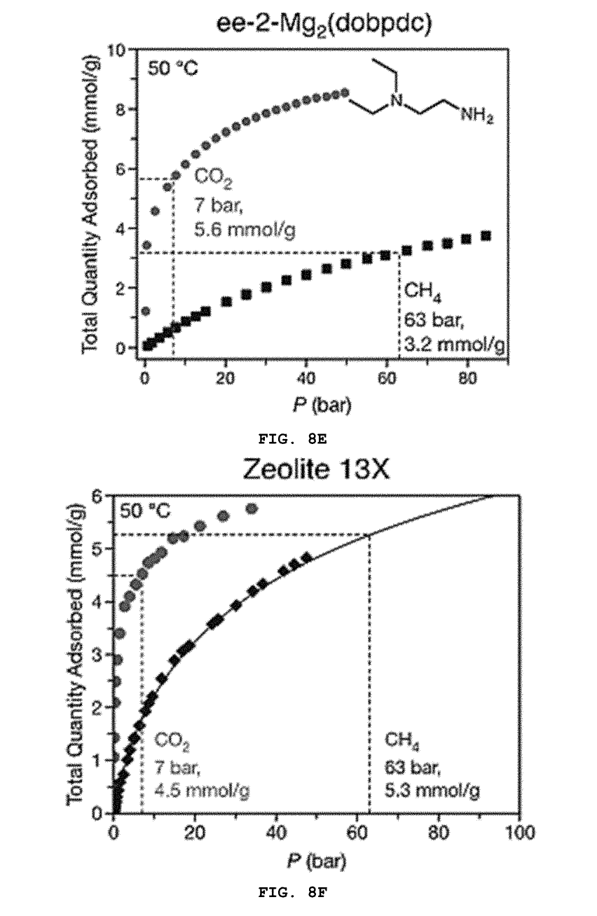

To increase the threshold pressure for cooperative adsorption, the diamine was systematically varied to increase both the binding strength of the metal-bound amine and the barrier to the initial proton transfer at the unbound amine. In this manner, the compounds ii-2-Mg₂(dobpdc) and ee-2-Mg₂(dobpdc) were identified. The single-component CO₂ adsorption isotherms for these materials, shown in FIG. 8A-C, indicate that the threshold pressure for adsorption reaches 1 bar by 40° C. for ii-2-Mg₂(dobpdc) and by 75° C. for ee-2-Mg₂(dobpdc).

The disclosure thus provides for the preparation of metal-organic frameworks comprising reactive amine groups that are capable of forming ammonium carbamate when contacted with CO₂ under cooperative adsorption characteristics. The diamine-appended MOFs of the disclosure have selectivity for adsorbing and separating, e.g., CO₂ from a mixed fluid (e.g., a gas stream) at pressures above 1 bar and/or temperatures of about 30-80° C.

In a particular embodiment, the disclosure provides for diamine-appended MOFs comprising a repeating core having the general structure

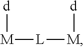

wherein M is transition metal or metal ion, d is diamine appendage, and L is a linking moiety comprising a structure of Formula I, II and/or Formula III:

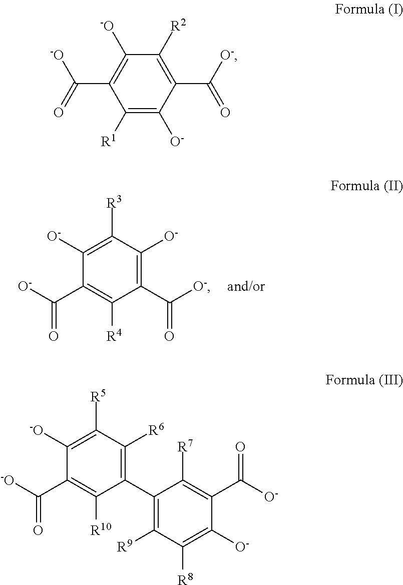

wherein,

R¹-R¹⁰ are independently selected from H, D, FG, optionally substituted (C₁-C₁₂)alkyl, optionally substituted hetero-(C₁-C₁₂)alkyl, optionally substituted (C₁-C₁₂)alkenyl, optionally substituted hetero-(C₁-C₁₂)alkenyl, optionally substituted (C₁-C₁₂)alkynyl, optionally substituted hetero-(C₁-C₁₂)alkynyl, optionally substituted (C₁-C₁₂)cycloalkyl, optionally substituted (C₁-C₁₂)cycloalkenyl, optionally substituted aryl, optionally substituted heterocycle, optionally substituted mixed ring system, —C(R¹¹)₃, —CH(R¹¹)₂, —CH₂R¹, —C(R¹²)₃, —CH(R¹²)₂, —CH₂R¹², —OC(R¹¹⁾₃, OCH(R¹¹)₂, —OCH₂R¹¹, —OC(R¹²)₃, —OCH(R¹²)₂, OCH₂R¹²;

R¹¹ is selected from FG, optionally substituted (C₁-C₁₂)alkyl, optionally substituted hetero-(C₁-C₁₂) alkyl, optionally substituted (C₁-C₁₂) alkenyl, optionally substituted hetero-(C₁-C₁₂) alkenyl, optionally substituted (C₁-C₁₂)alkynyl, optionally substituted hetero-(C₁-C₁₂)alkynyl, hemiacetal, hemiketal, acetal, ketal, and orthoester; and

R¹² is selected from one or more substituted or unsubstituted rings selected from cycloalkyl, aryl and heterocycle.

In a further embodiment, the disclosure provides for diamine-appended MOFs comprising a repeating core having the general structure

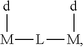

wherein M is a transition metal or metal ion, d is a diamine appendage, and L is a linking moiety comprising a structure of Formula I, II and/or Formula III:

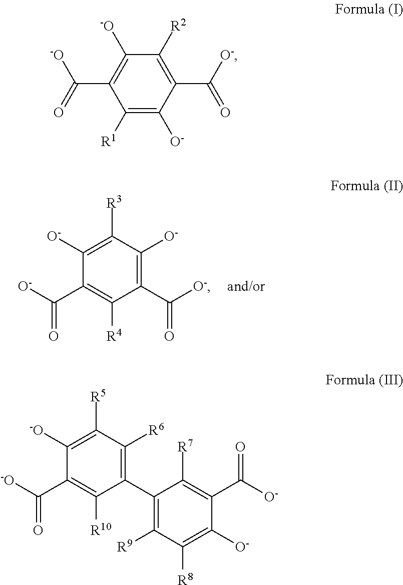

wherein,

R¹-R¹⁰ are independently selected from H, halo, amino, amide, imine, azide, methyl, cyano, nitro, nitroso, hydroxyl, aldehyde, carbonyl, ester, thiol, sulfinyl, sulfonyl, and thiocyanate.

In a particular embodiment, the disclosure provides for a diamine-appended MOF which comprises one or more metals or metal ions selected from: Li⁺, Na⁺, K⁺, Rb⁺, Cs⁺, Be²⁺, Mg²⁺, Ca²⁺, Sr²⁺, Ba²⁺, Sc³⁺, Sc²⁺, Sc⁺, Y³⁺, Y²⁺, Y+, Ti⁴⁺, Ti³⁺, Ti²⁺, Zr⁴⁺, Zr³⁺, Zr²⁺, Hf⁴⁺, Hf³⁺, V⁵⁺, V⁴⁺, V³⁺, V²⁺, Nb⁵⁺, Nb⁴⁺, Nb³⁺, Nb²⁺, Ta⁵⁺, Ta⁴⁺, Ta³⁺, Ta²⁺, Cr⁶⁺, Cr⁵⁺, Cr⁴⁺, Cr³⁺, Cr²⁺, Cr⁺, Cr, Mo⁶⁺, Mo⁵⁺, Mo⁴⁺, Mo³⁺, Mo²⁺, Mo⁺, Mo, W⁶⁺, W⁵⁺, W⁴⁺, W³⁺, W²⁺, W⁺, W, Mn⁷⁺, Mn⁶⁺, Mn⁵⁺, Mn⁴⁺, Mn³⁺, Mn²⁺, Mn⁺, Re⁷⁺, Re⁶⁺, Re⁵⁺, Re⁴⁺, Re³⁺, Re²⁺, Re⁺, Re, Fe⁶⁺, Fe⁴⁺, Fe³⁺, Fe²⁺, Fe⁺, Fe, Ru⁸⁺, Ru⁷⁺, Ru⁶⁺, Ru⁴⁺, Ru³⁺, Ru²⁺, Os⁸⁺, Os⁷⁺, Os⁶⁺, Os⁵⁺, Os⁴⁺, Os³⁺, Os²⁺, Os⁺, Os, Co⁵⁺, Co⁴⁺, Co³⁺, Co²⁺, Co⁺, Rh⁶⁺, Rh⁵⁺, Rh⁴⁺, Rh³⁺, Rh²⁺, Rh⁺, Ir⁶⁺, Ir⁵⁺, Ir⁴⁺, Ir³⁺, Ir²⁺, Ir⁺, Ir, Ni³⁺, Ni²⁺, Ni⁺, Ni, Pd⁶⁺, Pd⁴⁺, Pd²⁺, Pd⁺, Pd, Pt⁶⁺, Pt⁵⁺, Pt⁴⁺, Pt³⁺, Pt²⁺, Pt⁺, Cu⁴⁺, Cu³⁺, Cu²⁺, Cu⁺, Ag³⁺, Ag²⁺, Ag⁺, Au⁵⁺, Au⁴⁺, Au³⁺, Au²⁺, Au⁺, Zn²⁺, Zn⁺, Zn, Cd²⁺, Cd⁺, Hg⁴⁺, Hg²⁺, Hg⁺, B³⁺, B²⁺, B⁺, Al³⁺, Al²⁺, Al⁺, Ga³⁺, Ga²⁺, Ga⁺, In³⁺, In²⁺, In¹⁺, Tl³⁺, Tl⁺, Si⁴⁺, Si³⁺, Si²⁺, Si⁺, Ge⁴⁺, Ge³⁺, Ge²⁺, Ge⁺, Ge, Sn⁴⁺, Sn²⁺, Pb⁴⁺, Pb²⁺, As⁵⁺, As³⁺, As²⁺, As⁺, Sb⁵⁺, Sb³⁺, Bi⁵⁺, Bi³⁺, Te⁶⁺, Te⁵⁺, Te⁴⁺, Te²⁺, La³⁺, La²⁺, Ce⁴⁺, Ce³⁺, Ce²⁺, Pr⁴⁺, Pr³⁺, Pr²⁺, Nd³⁺, Nd²⁺, Sm³⁺, Sm²⁺, Eu³⁺, Eu²⁺, Gd³⁺, Gd²⁺, Gd⁺, Tb⁴⁺, Tb³⁺, Tb²⁺, Tb⁺, Db³⁺, Db²⁺, Ho³⁺, Er³⁺, Tm⁴⁺, Tm³⁺, Tm²⁺, Yb³⁺, Yb²⁺, Lu³⁺, La³⁺, La²⁺, La⁺, and combinations thereof, including any complexes which contain the metals or metal ions, as well as any corresponding metal salt counter-anions. In another embodiment, the diamine-appended MOFs disclosed herein comprise one or more divalent metal ions selected from: Be²⁺, Mg²⁺, Ca²⁺, Sr²⁺, Ba²⁺, Sc²⁺, Y²⁺, Ti²⁺, Zr²⁺, V²⁺, Nb²⁺, Ta²⁺, Cr²⁺, Mo²⁺, W²⁺, Mn²⁺, Re²⁺, Fe²⁺, Ru²⁺, Os²⁺, Co²⁺, Rh²⁺, Ir²⁺, Ni²⁺, Pd²⁺, Pt²⁺, Cu²⁺, Ag²⁺, Au²⁺, Zn²⁺, Cd²⁺, Hg²⁺, B²⁺, Al²⁺, Ga²⁺, In²⁺, Si²⁺, Ge²⁺, Sn²⁺, Pb²⁺, As²⁺, Te²⁺, La²⁺, Ce²⁺, Pr²⁺, Nd²⁺, Sm²⁺, Eu²⁺, Gd²⁺, Tb²⁺, Db²⁺, Tm²⁺, Yb²⁺, and La²⁺, including any complexes which contain the metal ions, as well as any corresponding metal salt counter-anions. In a particular embodiment, the MOF disclosed herein comprise Mg²⁺.

In another embodiment, the disclosure provides for production of diamine-appended MOFs comprising the structure of

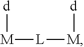

wherein M is a transition metal or metal ion, L comprises a structure of Formula I, II, or III described above, and d is a diamine appendage comprising a tertiary amine and wherein the diamine appendage is connected to M via a coordinate bond. Examples of diamine appendages include diamine-containing compounds which have the general formula of Compound I:

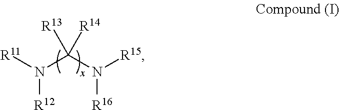

wherein,

R¹¹-R¹² are each independently selected from H, D, an optionally substituted (C₁-C₃)alkyl, an optionally substituted (C₂-C₃)alkenyl, —C(═O)CH₃, and hydroxyl, wherein at least 1 of R¹¹-R¹² are an H;

R¹³-R¹⁴ are each independently selected from H, D, FG, an optionally substituted (C₁-C₆)alkyl, an optionally substituted hetero-(C₁-C₆)alkyl, an optionally substituted (C₂-C₃)alkenyl, an optionally substituted hetero(C₂-C₃)alkenyl, an optionally substituted (C₂-C₆)alkynyl, an optionally substituted hetero(C₂-C₆)alkynyl, cycloalkyl, aryl, and heterocycle;

R¹⁵-R¹⁶ are each independently an FG, an optionally substituted (C₁-C₆)alkyl, an optionally substituted hetero-(C₁-C₆)alkyl, an optionally substituted (C₂-C₃)alkenyl, an optionally substituted hetero(C₂-C₃)alkenyl, an optionally substituted (C₂-C₆)alkynyl, an optionally substituted hetero(C₂-C₆)alkynyl, cycloalkyl, aryl, and heterocycle, and x is an integer from 1 to 6.

In a further embodiment, the diamine appendage is a diamine-containing compound that comprises the structure of Compound I(a):

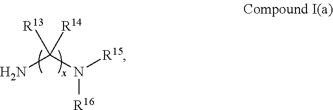

wherein,

R¹³-R¹⁴ are each independently selected from H, D, an optionally substituted (C₁-C₆)alkyl, and an optionally substituted hetero-(C₁-C₆)alkyl;

R¹⁵-R¹⁶ are each independently an optionally substituted (C₁-C₃)alkyl or an optionally substituted hetero-(C₁-C₃)alkyl; and

x is an integer from 1 to 6.

In an alternate embodiment, the diamine appendage is a diamine-containing compound that is selected from 1,2-diaminopropane; N,N-diethylethylenediamine; 2-(diisopropylamino) ethylamine; N,N′-dimethyl ethylenediamine; N-propylethylenediamine; N-butyl ethylenediamine; N,N-dimethyl-N′-ethyl ethylenediamine; 1,2-diaminocyclohexane; diethylenetriamine; N-(2-aminoethyl)-1,3-propanediamine; N-isopropyl diethylenetriamine; triethylenetetramine; tris(2-aminoethyl) amine; piperazine; 1-(2-aminoethyl) piperazine; N,N,N′,N′-tetramethyldiamino methane; N,N,N′-trimethylethylenediamine; 3-(dimethylamino)-1-propylamine; 4-(2-aminoethyl)morpholine; N-(2-hydroxyethyl)ethylenediamine; N,N-diethylethylenetriamine; N,N-diisopropylethylenediamine; N,N,N′-trimethylethylenediamine; 1-(2-aminoethyl)-pyrrolidine; 1-(2-aminoethyl)piperidine; and N-(2-hydroxyethyl)ethylenediamine.

In another embodiment, the MOF comprises a structure

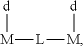

wherein M is Mg²⁺, L comprises Formula I, II, or III and d is a N,N-diethylethylenediamine or N,N-diisopropylethylenediamine appended group.

All the aforementioned linking ligands possess appropriate reactive functionalities can be chemically transformed by a suitable reactant post synthesis of the framework to add further functionalities to the framework. By modifying the organic links within the framework post-synthetically, access to functional groups that were previously inaccessible or accessible only through great difficulty and/or cost is possible and facile.

In a further embodiment, the diamine-appended MOFs of the disclosure may be further modified by reacting with one or more post framework reactants that may or may not have denticity. In another embodiment, a diamine-appended MOF as-synthesized is reacted with at least one, at least two, or at least three post framework reactants. In yet another embodiment, a diamine-appended MOF as-synthesized is reacted with at least two post framework reactants. In a further embodiment, a diamine-appended MOF as-synthesized is reacted with at least one post framework reactant that will result in adding denticity to the framework.

The disclosure provides that a diamine-appended MOF disclosed herein can be modified by a post framework reactant by using chemical reactions that modify, substitute, or eliminate a functional group post-synthesis. These chemical reactions may use one or more similar or divergent chemical reaction mechanisms depending on the type of functional group and/or post framework reactant used in the reaction. Examples of chemical reaction include, but are not limited to, radical-based, unimolecular nucleophilic substitution (SN1), bimolecular nucleophilic substitution (SN2), unimolecular elimination (El), bimolecular elimination (E2), E1cB elimination, nucleophilic aromatic substitution (SnAr), nucleophilic internal substitution (SNi), nucleophilic addition, electrophilic addition, oxidation, reduction, cycloaddition, ring closing metathesis (RCM), pericylic, electrocylic, rearrangement, carbene, carbenoid, cross coupling, and degradation. Other agents can be added to increase the rate of the reactions disclosed herein, including adding catalysts, bases, and acids.

In another embodiment, a post framework reactant adds at least one effect to a diamine-appended MOF of the disclosure including, but not limited to, modulating the aromatic hydrocarbon storage and/or separation ability of the diamine-appended MOF; modulating the sorption properties of the MOF; modulating the pore size of the diamine-appended MOF; modulating the catalytic activity of the diamine-appended MOF; modulating the conductivity of the diamine-appended MOF; modulating the metal-metal separation distance of the MOF; and modulating the sensitivity of the diamine-appended MOF to the presence of an analyte of interest. In a further embodiment, a post framework reactant adds at least two effects to the diamine-appended MOF of the disclosure including, but not limited to, modulating the aromatic hydrocarbon storage and/or separation ability of the diamine-appended MOF; modulating the sorption properties of the diamine-appended MOF; modulating the pore size of the diamine-appended MOF; modulating the catalytic activity of the diamine-appended MOF; modulating the conductivity of the diamine-appended MOF; modulating the metal-metal separation distance of the diamine-appended MOF; and modulating the sensitivity of the diamine-appended MOF to the presence of an analyte of interest.

Sorption is a general term that refers to a process resulting in the association of atoms or molecules with a target material. Sorption includes both adsorption and absorption. Absorption refers to a process in which atoms or molecules move into the bulk of a porous material, such as the absorption of water by a sponge. Adsorption refers to a process in which atoms or molecules move from a bulk phase (that is, solid, liquid, or gas) onto a solid or liquid surface. The term adsorption may be used in the context of solid surfaces in contact with liquids and gases. Molecules that have been adsorbed onto solid surfaces are referred to generically as adsorbates, and the surface to which they are adsorbed as the substrate or adsorbent. Adsorption is usually described through isotherms, that is, functions which connect the amount of adsorbate on the adsorbent, with its pressure (if gas) or concentration (if liquid). In general, desorption refers to the reverse of adsorption, and is a process in which molecules adsorbed on a surface are transferred back into a bulk phase. The diamine-appended MOFs of the disclosure can therefore be used as selective adsorbents of CO₂. Furthermore, the diamine-appended MOFs of the disclosure can be used to separate a mixture of gases.

In particular embodiment, the disclosure provides for diamine-appended MOFs that can be tuned to adsorb CO₂ from a mixture comprising CO₂ and at least one other gas. High pressure, pure component isotherms of the N,N-diisopropylethylenediamine-2-Mg₂(dobpdc) material enabled an assessment of CO₂/CH₄ selectivity. As shown in FIG. 8C, the incorporation of CO₂-specific functionality within the framework strongly favors adsorption of CO₂ over CH₄ (see FIG. 8C, left panel). The advantage of cooperative adsorption is readily apparent by comparison to a standard adsorbent, zeolite 13X (see FIG. 8C, right). At high pressures, the zeolite adsorbs significantly more CH₄ than the diamine-appended framework, translating to loss of product gas recovery and depletion of the working capacity of the bed. Further, because the zeolite binds CO₂ strongly at atmospheric pressure, regeneration in a pressure-swing process would require either vacuum or heating to liberate the 3.1 mmol/g CO₂ adsorbed at 1 bar and 50° C. In contrast, for diisopropylethylenediamine-2-Mg₂(dobpdc), the CO₂ adsorption isotherm is nearly flat prior to cooperative adsorption, with only 0.2 mmol/g CO₂ adsorbed at 50° C. and 1 bar.

Natural gas is an important fuel gas and it is used extensively as a basic raw material in the petrochemical and other chemical process industries. The composition of natural gas varies widely from field to field. Many natural gas reservoirs contain relatively low percentages of hydrocarbons (less than 40%, for example) and high percentages of acid gases, principally carbon dioxide, but also hydrogen sulfide, carbonyl sulfide, carbon disulfide and various mercaptans. Removal of acid gases from natural gas produced in remote locations is desirable to provide conditioned or sweet, dry natural gas either for delivery to a pipeline, natural gas liquids recovery, helium recovery, conversion to liquefied natural gas (LNG), or for subsequent nitrogen rejection. CO₂ is corrosive in the presence of water, and it can form dry ice, hydrates and can cause freeze-up problems in pipelines and in cryogenic equipment often used in processing natural gas. Also, by not contributing to the heating value, CO₂ merely adds to the cost of gas transmission.

An important aspect of any natural gas treating process is economics. Natural gas is typically treated in high volumes, making even slight differences in capital and operating costs of the treating unit significant factors in the selection of process technology. Some natural gas resources are now uneconomical to produce because of processing costs. There is a continuing need for improved natural gas treating processes that have high reliability and represent simplicity of operation.

In one embodiment of the disclosure, an acid gas separation material comprising one or more diamine-appended MOFs of the disclosure is provided. Advantageously, the diamine-appended MOFs of the disclosure include a number of adsorption sites for storing and/or separating one or more component gases (e.g., acid gases) from flue gas or a fuel gas stream (e.g., natural gas, town gas, and syngas). Examples of such component gases include acid gases, like carbon dioxide, hydrogen sulfide, carbon sulfide, carbonyl sulfide, and various mercaptans; sour gas (i.e., H₂S); water vapor; nitrogen; and carbon monoxide. For example, methane, butane, isobutene, and/or propane can be effectively separated from any of the foregoing component gases by using an amine-appended MOF of disclosure.

In addition, removal of carbon dioxide from the flue exhaust of power plants, currently a major source of anthropogenic carbon dioxide is commonly accomplished by chilling and pressurizing the exhaust or by passing the fumes through a fluidized bed of aqueous amine solution, both of which are costly and inefficient. Other methods based on chemisorption of carbon dioxide on oxide surfaces or adsorption within porous silicates, carbon, and membranes have been pursued as means for carbon dioxide uptake. However, in order for an effective adsorption medium to have long term viability in carbon dioxide removal it should have the following features: (i) a periodic structure for which carbon dioxide uptake and release is fully reversible, (ii) a flexibility with which chemical functionalization and molecular level fine-tuning can be achieved for optimized uptake capacities, and (iii) be capable of reversibly adsorbing carbon dioxide at a pressure above 1 bar and at temperatures between 30-80° C. Accordingly, the diamine-appended MOFs of the disclosure are ideally suited for separating and/or storing CO₂ from flue exhaust.

Also provided by the disclosure are devices for the sorptive uptake of a chemical species. The device includes a sorbent comprising a diamine-appended framework provided herein or obtained by the methods of the disclosure. The uptake is typically reversible but in certain limited cases can be non-reversible. In some embodiments, the sorbent is included in discrete sorptive particles. The sorptive particles may be embedded into or fixed to a solid liquid- and/or gas-permeable three-dimensional support. In some embodiment, the sorptive particles have pores for the reversible uptake or storage of liquids or gases and wherein the sorptive particles can reversibly adsorb or absorb the liquid or gas.

Also provided herein are methods for the sorptive uptake of a chemical species. The method includes contacting the chemical species with a sorbent that comprises a framework provided herein. The uptake of the chemical species may include storage of the chemical species, such as carbon dioxide. In some embodiments, the chemical species is stored at pressure exceeding 1 bar and a temperature between 30-80° C.

Also provided herein are methods for the sorptive uptake of a chemical species which includes contacting the chemical species with a device provided herein. In further embodiments, the disclosure provides a device, such as a membrane, filtration/separation column, or fixed bed, which comprises one or more diamine-appended MOFs disclosed herein. In specific embodiments a fluid mixture is processed using the materials and devices of the disclosure to deplete a gaseous mixture of one or more component fluids (e.g., CO₂, CO, H₂S, OCS, etc.) to give a fluid mixture that is enriched with one or more desired component fluids (e.g., CH₄, H₂, C₃H₈, C₄H₁₀). In further embodiments, the fluid mixture is natural gas, the one or more fluids that are depleted from the gas mixture are acid gases (e.g., CO₂), and the effluent is enriched with methane. In yet further embodiments, the disclosure provides for the purification of a fuel gas, such as natural gas, by passing an influent stream of fuel gas through a device or material comprising a diamine-appended MOF disclosed herein, wherein the effluent stream comprises less acid gases, such as CO₂, then the fuel gas influent stream. In a particular embodiment, the disclosure provides for the purification of natural gas, by passing an influent stream of natural gas through a device or material comprising a diamine-appended MOF disclosed herein, wherein the effluent stream comprises less CO₂ then the natural gas influent stream.

The disclosure includes simple separation systems where a fixed bed of adsorbent comprised of a diamine-appended MOF material disclosed herein is exposed to a linear flow of a fluid mixture. This type of setup is referred to as “fixed bed separation.” However, the diamine-appended MOFs can be used for fluid separation in more complex systems that include any number of cycles, which are numerous in the chemical engineering literature. Examples of these include pressure swing adsorption (PSA), temperature swing adsorption (TSA), a combination of those two, cycles involving low pressure desorption, and also processes where the diamine-appended MOF material is incorporated into a membrane and used in the numerous membrane-based methods of separation.

Pressure swing adsorption processes rely on the fact that under pressure, gases tend to be attracted to solid surfaces, or “adsorbed”. The higher the pressure, the more fluid is adsorbed; when the pressure is reduced, the fluid is released, or desorbed. PSA processes can be used to separate gases in a mixture because different gases tend to be attracted to different solid surfaces more or less strongly. If a gas mixture such as air, for example, is passed under pressure through a vessel comprising a diamine-appended MOF of the disclosure that attracts CO₂ more strongly than other components of the mixed fluid gas, part or all of the CO₂ will stay in the bed, and the gas coming out of the vessel will be depleted in CO₂. When the bed reaches the end of its capacity to adsorb CO₂, it can be regenerated. It is then ready for another cycle of CO₂ separation.

Temperature swing adsorption devices function in a similar manner, however instead of the pressure being changed, the temperature is changed to adsorb or release the bound fluid, like CO₂. Such systems can also be used with the diamine-appended MOF of the disclosure.

The disclosure provides an apparatus and method for separating one or more components from a multi-component fluid using a separation system (e.g., a fixed-bed system and the like) having a feed side and an effluent side separated by a MOF of the disclosure. The diamine-appended MOF may comprise a column or membrane separation format.

As used herein a multi-component fluid refers to a liquid, air or gas. The fluid may be an atmospheric gas, air or may be present in an exhaust or other by-product of a manufacturing process.

The following examples are intended to illustrate but not limit the disclosure. While they are typical of those that might be used, other procedures known to those skilled in the art may alternatively be used.

### EXAMPLES

### Synthesis of 4,4′-Dihydroxy-(1,1′-biphenyl)-3,3′-dicarboxylic Acid (H₄(dobpdc))

The compound H₄(dobpdc) was prepared as reported previously via Kolbe-Schmitt carboxylation of the sodium salt of 4,4′-biphenol with pressurized CO₂ (Kolbe, H. Justus Liebigs Ann. Chem. 1860, 113, 125-127; Schmitt, R. J. Prakt. Chem. 1885, 31, 397-411; and Lindsey, A. S.; Jeskey, H. Chem. Rev. 1957, 57 (4), 583-620).

### Synthesis and Activation of Mg₂(dobpdc)

The framework Mg₂(dobpdc) was synthesized by a solvothermal method scaled from a previous report (McDonald et al., Nature 519:303-308, 2015). The ligand H₄(dobpdc) (9.89 g, 36.1 mmol), Mg(NO₃)₂.6H₂O (11.5 g, 44.9 mmol), and 200 mL of 55:45 methanol/dimethylformamide (DMF) were added to a 350 mL glass pressure vessel with a glass stirbar. The reactor was sealed with a Teflon cap and heated in a silicone oil bath at 120° C. for 20 h. The crude white powder was isolated by filtration and soaked three times in DMF at 60° C. and three times in methanol at 60° C. for a minimum of 3 h each. The washed solid was collected by filtration and fully desolvated in vacuo or under flowing N₂ for 1.5 h at 320° C., then 12 h at 250° C. Combustion elemental analysis calculated for C₁₄H₆O₆Mg₂: C, 52.74; H, 1.90. Found: C, 53.00, H, 1.56.

### General Synthesis of Diamine-Appended Mg₂(dobpdc) Frameworks

Amine-grafting conditions for preparing ee-2-Mg₂(dobpdc) (ee-2-=N,N-diethylethylenediamine), ii-2-Mg₂(dobpdc) (ii-2-=N,N-diisopropylethylenediamine), and other diamine-appended variants of this framework series were adopted from a previous report (McDonald et al., supra). Following desolvation of the parent framework as described above, a 10- to 20-fold molar excess of diamine per metal site was added via cannula transfer as a dry, 20% solution by volume in toluene. The reaction vessel was sonicated for 20 min under N₂ and then left undisturbed under an N₂ atmosphere for a minimum of 18 h. The powder was isolated by filtration and washed three times with dry toluene and three times with dry hexanes at room temperature.

Pelletization of Diamine-Appended Mg₂(dobpdc) Frameworks.

For all dynamic breakthrough measurements, 25-45 mesh pellets of adsorbent were prepared by mechanical compression. Pellets were formed from powder samples of the diamine-grafted framework prior to activation from toluene or hexanes. The powdered material was placed in a stainless-steel cylinder between highly polished faces of a stainless-steel platform and corresponding stainless-steel plunger. A mechanical press was used to compress the powder between the platform and plunger to form a tablet. This tablet was then broken to the desired particle size between 25 and 45 mesh sieves.

Activation of Diamine-Appended Mg₂(dobpdc) Frameworks.

Prior to adsorption measurements, the powdered or pelletized sample was desolvated by heating in vacuo or under flowing N₂ at temperatures ranging from 100 to 150° C. for a minimum of 12 h.

Quantification of Diamine Grafting.

Due to the cooperative nature of CO₂ adsorption in diamine-appended Mg₂(dobpdc) frameworks, near complete coverage of 1 diamine per metal site is essential to achieve high selectivity for CO₂. Following post-synthetic functionalization, diamine grafting was quantified by one or more of the following: combustion elemental analysis, NMR digestion, thermogravimetric (TGA) decomposition, and the CO₂ capacity at the saturation point of the single-component isotherm step. For combustion analysis, the sample was activated and stored in an N₂-filled glovebox prior to analysis. For NMR digestion, approximately 5 mg of material was digested in 20 μL of DCl (35 wt. % in D₂O) and 0.5 mL of deutero-DMSO. For TGA decomposition, 4 to 10 mg of sample was heated at a ramp rate of 2° C./min under an inert gas. Diamine loss was quantified from the step change in weight observed following desolvation of the framework but prior to framework decomposition.

For a representative sample of ii-2-Mg₂(dobpdc), the following combustion elemental analysis was obtained: Calculated: C, 59.33; H, 7.63; N, 9.23. Found: C, 59.50; H, 7.62; N, 9.46. TGA analysis of this sample indicated ˜97% coverage of diamines to metal sites.

For a representative sample of ee-2-Mg₂(dobpdc), the following combustion elemental analysis was obtained: Calculated for C₂₆H₃₈Mg₂N₄O₆: C, 56.65; H, 6.95; N, 10.16. Found: C, 56.38; H, 6.75; N, 9.84. TGA analysis of this sample indicated ˜97% coverage of diamines to metal sites.

Single-Component Gas Adsorption Measurements.

All gas adsorption measurements were conducted using volumetric methods with UHP-grade (99.97%) He, N₂, CO₂, and CH₄. Only oil-free vacuum pumps and oil-free pressure regulators were used. Micromeritics ASAP 2020 and ASAP 2420 instruments were used to collect low-pressure gas adsorption and desorption isotherms in the range of 0 to 1.2 bar. Glass analysis tubes were capped with a Transeal, evacuated, and weighed, after which the sample was loaded and the tube was heated in vacuo at the specified activation temperature. When the outgas rate was confirmed to fall below 2 mTorr/min, the tube was weighed to determine the mass of activated sample (typically 50 to 200 mg) and transferred to the analysis port of the instrument. Before beginning an analysis, an outgas rate of under 2 mTorr/min was again confirmed. All free-space corrections were measured using He, and N₂ isotherms at 77 K were measured by immersing tubes with isothermal jackets in liquid nitrogen baths. Langmuir surface areas were calculated from N₂ adsorption data at 77 K using Micromeritics software.

High-pressure gas sorption measurements in the range of 0 to 100 bar were conducted using a HPVA II from Particulate Systems, a subsidiary of Micromeritics. A tared, stainless steel sample holder was loaded with a minimum of 1 g of activated adsorbent inside a glovebox under N₂. The sample holder was sealed with Swagelok fittings and an airtight valve to prevent atmospheric exposure during transfer to the high-pressure system. Prior to sample measurement, an empty sample holder was used to collect background CO₂ adsorption isotherms at 25° C., 40° C., and 50° C. A small negative background was observed at high pressures and can likely be attributed to volume or temperature calibration errors or errors in the equation of state used to correct for non-ideality. The background adsorption was found to be consistent over several measurements, and polynomial fits of replicate data sets at each temperature were used to perform background subtraction on experimental data sets.

Thermogravimetric Cycling.

CO₂/CH₄ and CO₂/CH₄/H₂O TGA experiments were conducted to assess the performance of the ee-2-Mg₂(dobpdc) material during cycling and in the presence of water. The sample was first activated under flowing N₂ at 120° C. for 90 min. Next, the sample was cooled to the desired set point temperature (30, 40, or 50° C.) and held isothermal for the duration of the experiment. The sample was allowed to equilibrate under N₂ at the set point temperature for 10 min, after which the gas flow was switched from N₂ to CH₄ and allowed to equilibrate for an additional 10 min. The first adsorption cycle was then initiated by switching from 100% CH₄ to 100% CO₂. Following 20 min of CO₂ adsorption, the gas feed was returned to 100% CH₄, and the sample was purged isothermally for 90 min. Additional cycles followed the same progression of 20 min adsorption under 100% CO₂ and 90 min isothermal desorption with pure CH₄. Following dry CO₂/CH₄ cycling at 30, 40, and 50° C., the experiments were repeated under humid conditions by inserting a water bubbler between the gas feed and the furnace inlet.

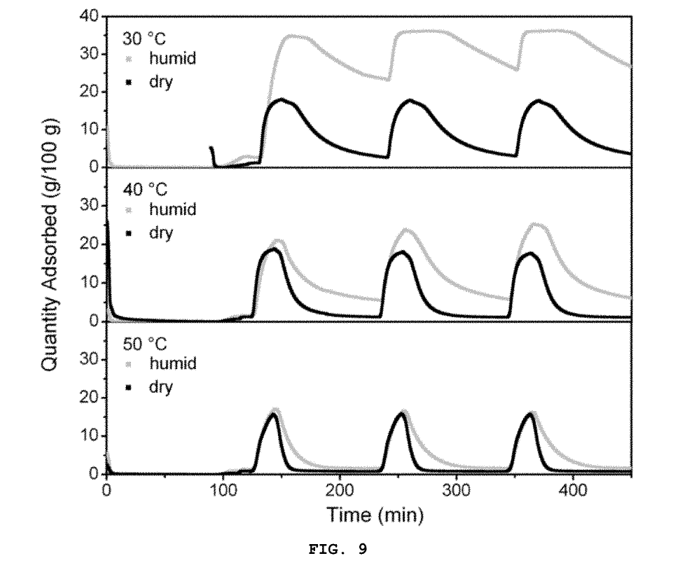

As shown in FIG. 9, steady capacities can be achieved for dry CO₂/CH₄ cycling in the range of 30 to 50° C. Under humid conditions, a significant amount of water co-adsorption was observed at lower temperatures. Because CO₂ adsorption is likely faster than H₂O adsorption, low-temperature adsorption may be possible by allowing water to remain in the bed as CO₂ is cycled. Adsorption at higher temperatures appeared less prone to significant co-adsorption of water, and minimal capacity loss was observed over 3 cycles.

Dynamic Breakthrough Multicomponent Adsorption Testing.

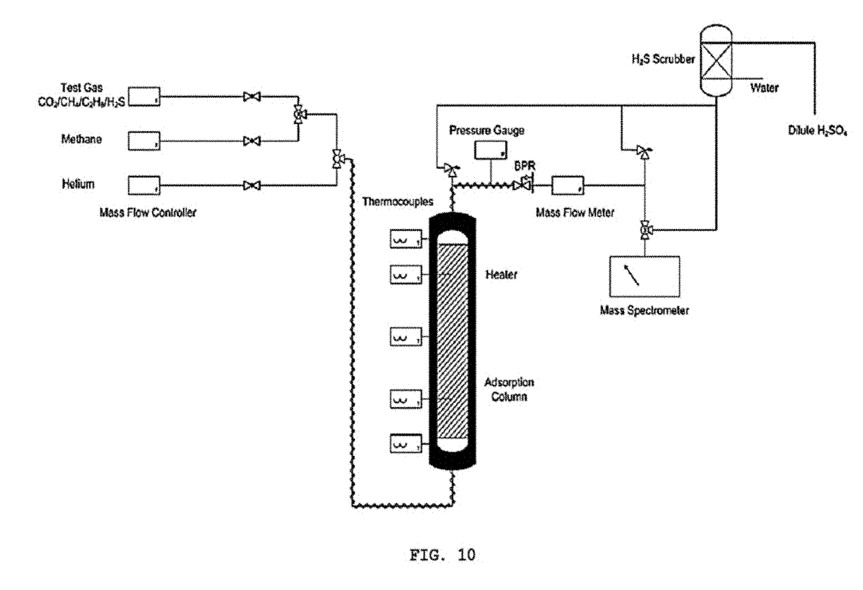

In order to understand the adsorption mechanism and behavior of gas mixtures in a packed bed adsorption column, dynamic breakthrough adsorption studying breakthrough curves are commonly used to assess the performance of different adsorbent materials. Dynamic adsorption experiments were carried out on a custom-built DCB apparatus, as shown in FIG. 10. The mass spectrometer monitored the signal of gases at the following masses: 4 m/z, 16 m/z, 44 m/z for helium, methane (CH₄), and carbon dioxide (CO₂), respectively. The bulk bed temperature was monitored using two thermocouples at approximately ¼th and ¾th the length of the bed during experiments, and the bed temperature was controlled by an external furnace with three heating zones. The bed temperatures were recorded every 30 s, and maximum temperature at the experimental time for each thermocouple was also recorded. Flow rates were recorded from the mass flow meter (MFM) immediately after the back-pressure regulator and immediately before the mass spectrometer. Adsorbents were activated at 100° C. under dynamic vacuum prior to pressurization with helium. Once steady flow was established with helium at the desired feed pressure, the test gas mass flow controller was turned on, and the adsorption experiment was carried out.

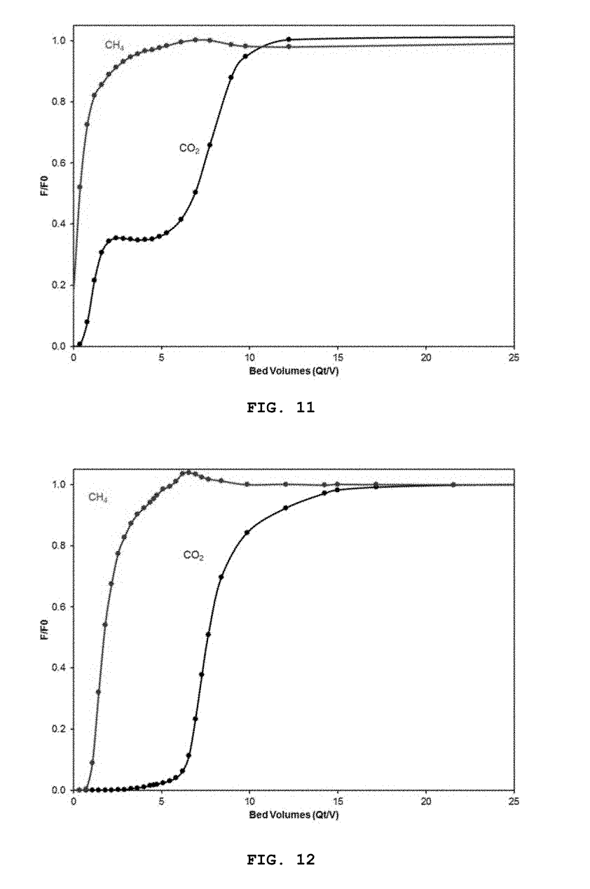

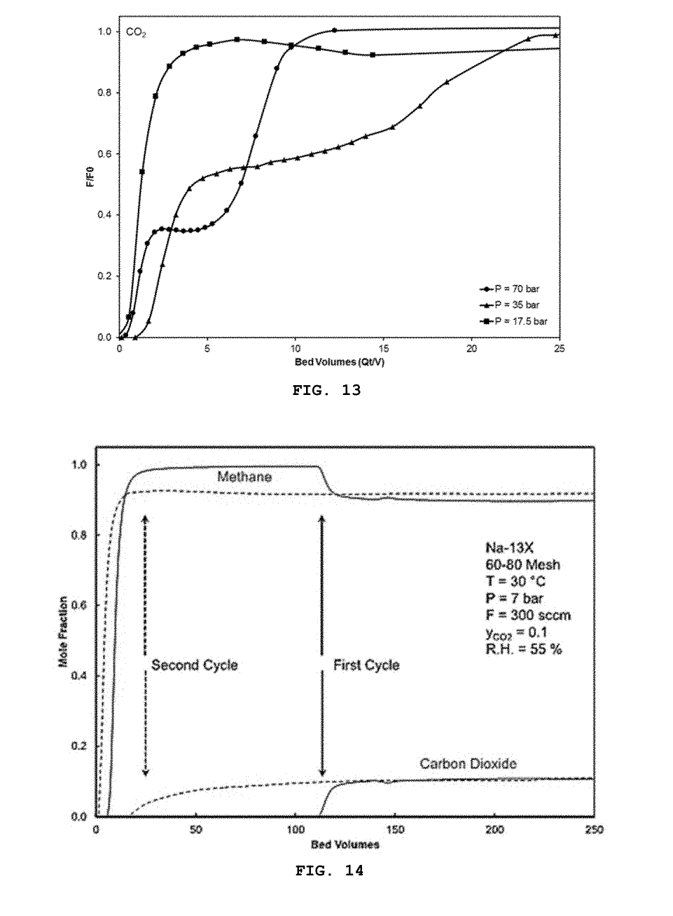

Representative breakthrough curves for ee-2-Mg₂(dopbdc) and ii-2-Mg₂(dopbdc) are shown in FIGS. 11 and 12. The gas mixture used in these breakthrough studies was 10 mol % CO₂ and 90 mol % CH₄ between pressures of 17 and 70 bar and between temperatures of 30 and 50° C. FIGS. 11 and 12 represent the adsorbent performance at 70 bar and 30° C. While the CO₂ partial pressure was more than one order of magnitude higher than the critical pressure for cooperative adsorption for both materials, an unexpected kinetic limitation in adsorption was observed for ii-2-Mg₂(dopbdc) compared with ee-2-Mg₂(dopbdc). This anomalous breakthrough behavior is further shown in FIG. 13, which compares the effect of feed pressure on the dynamic CO₂ breakthrough adsorption of ii-2-Mg₂(dopbdc). As the CO₂ partial pressure was decreased, lowering the ratio to the cooperative adsorption pressure, less adsorption of CO₂ was observed before breakthrough occurred, indicating a kinetic limitation in the cooperative adsorption due to the lower driving force for adsorption. Unlike ii-2-Mg₂(dopbdc), when ee-2-Mg₂(dopbdc) was examined at 70 bar, the CO₂ breakthrough capacity was 4.2 mol CO₂/kg adsorbent, suggesting no kinetic limitation in adsorption during breakthrough testing and no decrease in adsorption capacity compared to the pure CO₂ adsorption isotherms. Under these high pressure conditions, the adsorption profiles shown in this Example represent typical gas processing conditions and feeds expected for raw natural gas. This suggests ee-2-Mg₂(dopbdc) to be a highly selective adsorbent for CO₂—CH₄ separations at pressures representative of a natural gas field.

Additional dynamic breakthrough experiments were performed using a custom L&C pressure-swing adsorption instrument to compare the behavior of ee-2-Mg₂(dobpdc) and zeolite 13X under dry and humid conditions. An OmniStar mass spectrometer was used to monitor the breakthrough of He, CO₂, CH₄, and H₂O as a function of time. Experiments were carried out with dry or humidified 10% CO₂ in CH₄ at 30° C. with a total flow rate of 300 sccm and a total pressure of either 7 bar or 50 bar. Approximately 1 g of pelletized adsorbent (60-80 mesh) was used in each case. Prior to introduction of the CO₂/CH₄/H₂O mixture, the bed was pre-equilibrated under He at the pressure of interest.

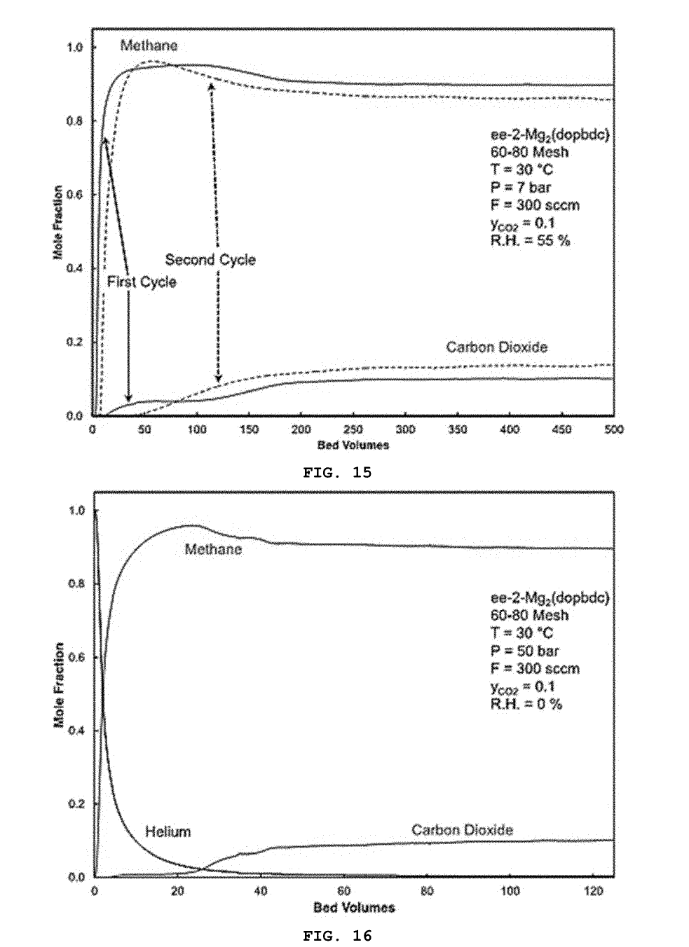

As expected for zeolite 13X, passivation of CO₂ adsorption sites by H₂O produced a drastic reduction in breakthrough time for the second cycle performed under 55% relative humidity at 7 bar (FIG. 14). In contrast, ee-2-Mg₂(dobpdc) was found to display only a minor reduction in breakthrough time upon the second cycle under the same conditions (FIG. 15). In addition, the slight slip of CO₂ prior to full breakthrough was suppressed for the second humidified cycle, indicating that the addition of H₂O may in fact improve the CO₂ capture performance of diamine-appended frameworks.

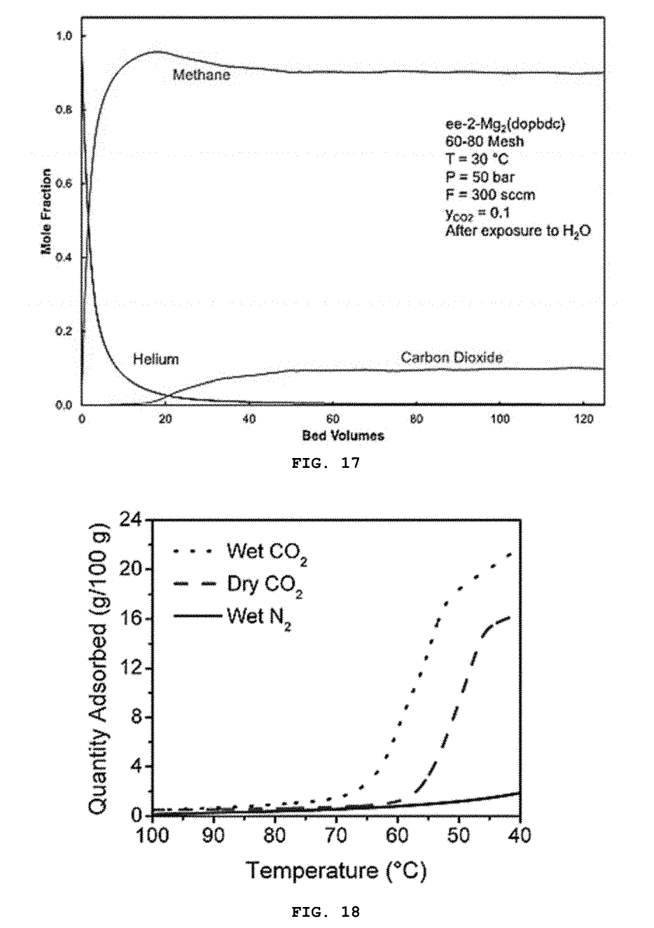

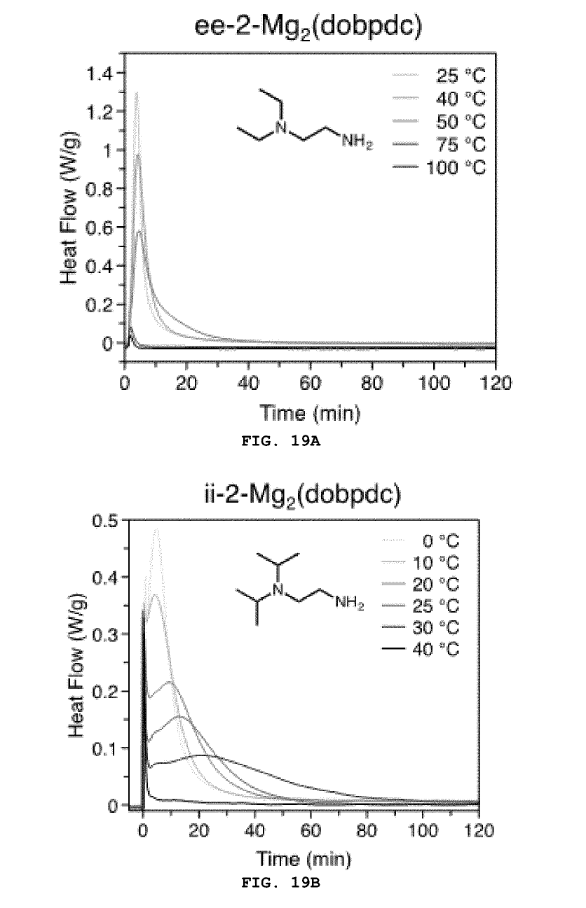

At 50 bar, ee-2-Mg₂(dobpdc) displayed reduced pre-breakthrough slip as compared to the 7 bar experiment (FIG. 16). Following pre-saturation of the ee-2-Mg₂(dobpdc) adsorbent bed with H₂O, a minimal reduction in breakthrough time as well as an additional reduction in pre-breakthrough slip was again observed, supporting the potential for humidified streams to improve the breakthrough performance of diamine-appended adsorbents (FIG. 17). As with the 7 bar case, retention of the majority of the breakthrough capacity even under humidified conditions is anticipated to afford a significant advantage over zeolite 13X, which would require activation under high temperature or strong vacuum to remove H₂O and restore the CO₂ capacity and selectivity of the bed.

While the exact nature of the improved performance of ee-2-Mg₂(dobpdc) under humid conditions is unclear, multicomponent thermogravimetric (FIG. 18) and volumeteric adsorption experiments suggest that the presence of H₂O can reduce the threshold pressure for cooperative adsorption at a given temperature, allowing the material to adsorb CO₂ at lower partial pressures than would be achievable for a dry CO₂ mixture.

A number of embodiments have been described herein. Nevertheless, it will be understood that various modifications may be made without departing from the spirit and scope of this disclosure. Accordingly, other embodiments are within the scope of the following claims.

1. A diamine-appended metal-organic framework (MOF) comprising a repeating core having the general structure 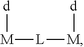
wherein M is a metal or metal ion, d is a diamine appendage comprising a tertiary amine and wherein the diamine appendage is connected to M via a coordinate bond, and L is a linking moiety comprising a structure of Formula I, II and/or Formula III: 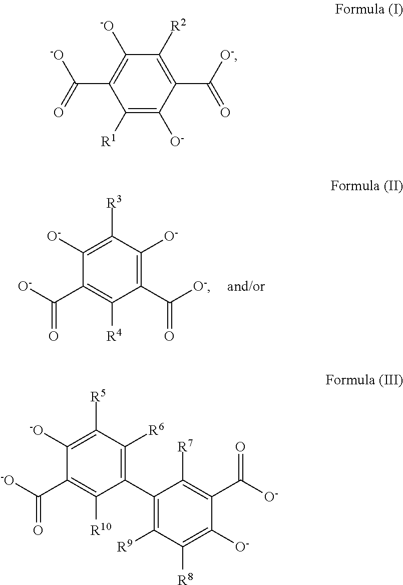
wherein,
R¹-R¹⁰ are independently selected from H, D, FG, optionally substituted (C₁-C₁₂)alkyl, optionally substituted hetero-(C₁-C₁₂)alkyl, optionally substituted (C₁-C₁₂)alkenyl, optionally substituted hetero-(C₁-C₁₂)alkenyl, optionally substituted (C₁-C₁₂)alkynyl, optionally substituted hetero-(C₁-C₁₂)alkynyl, optionally substituted (C₁-C₁₂)cycloalkyl, optionally substituted (C₁-C₁₂)cycloalkenyl, optionally substituted aryl, optionally substituted heterocycle, optionally substituted mixed ring system, —C(R¹¹)₃, —CH(R¹¹)₂, —CH₂R¹¹, —C(R¹²)₃, —CH(R¹²)₂, —CH₂R¹², —OC(R¹¹)₃, OCH(R¹¹)₂, —OCH₂R¹¹, —OC(R¹²)₃, —OCH(R¹²)₂, OCH₂R¹²;
R¹¹ is selected from FG, optionally substituted (C₁-C₁₂)alkyl, optionally substituted hetero-(C₁-C₁₂)alkyl, optionally substituted (C₁-C₁₂)alkenyl, optionally substituted hetero-(C₁-C₁₂)alkenyl, optionally substituted (C₁-C₁₂)alkynyl, optionally substituted hetero-(C₁-C₁₂)alkynyl, hemiacetal, hemiketal, acetal, ketal, and orthoester; and
R¹² is selected from one or more substituted or unsubstituted rings selected from cycloalkyl, aryl and heterocycle.

2. The diamine-appended MOF of claim 1, wherein the L is a linking moiety comprising a structure of Formula I, II and/or Formula III: 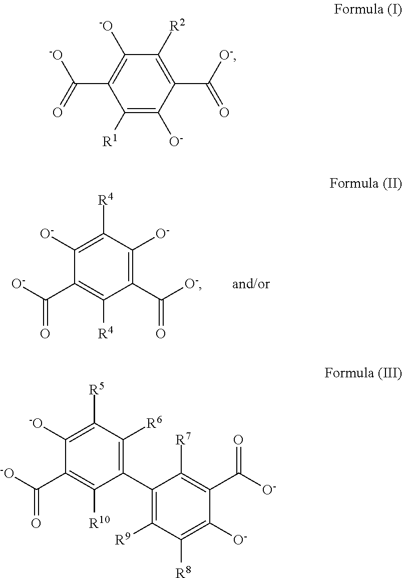
wherein,
R¹-R¹⁰ are independently selected from H, halo, amino, amide, imine, azide, methyl, cyano, nitro, nitroso, hydroxyl, aldehyde, carbonyl, ester, thiol, sulfinyl, sulfonyl, and thiocyanate.

3. The diamine-appended MOF of claim 1, wherein the L is a linking moiety comprising the structure of Formula (III): 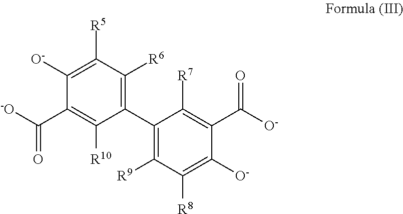
wherein, R⁵-R¹⁰ are H.

4. The diamine-appended MOF of claim 1, wherein d comprises the structure of Compound I: 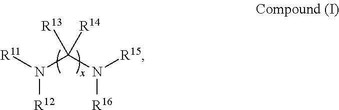
wherein,
R¹¹-R¹² are each independently selected from H, D, an optionally substituted (C₁-C₃)alkyl, an optionally substituted (C₂-C₃)alkenyl, —C(═O)CH₃, and hydroxyl, wherein at least 1 of R¹¹-R¹² are an H;
R¹³-R¹⁴ are each independently selected from H, D, FG, an optionally substituted (C₁-C₆)alkyl, an optionally substituted hetero-(C₁-C₆)alkyl, an optionally substituted (C₂-C₃)alkenyl, an optionally substituted hetero(C₂-C₃)alkenyl, an optionally substituted (C₂-C₆)alkynyl, an optionally substituted hetero(C₂-C₆)alkynyl, cycloalkyl, aryl, and heterocycle;
R¹⁵-R¹⁶ are each independently an FG, an optionally substituted (C₁-C₆)alkyl, an optionally substituted hetero-(C₁-C₆)alkyl, an optionally substituted (C₂-C₃)alkenyl, an optionally substituted hetero(C₂-C₃)alkenyl, an optionally substituted (C₂-C₆)alkynyl, an optionally substituted hetero(C₂-C₆)alkynyl, cycloalkyl, aryl, and heterocycle, and
x is an integer from 1 to 6.

5. The diamine-appended MOF of claim 4, wherein d comprises the structure of Compound I(a): 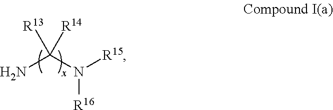
wherein,
R¹³-R¹⁴ are each independently selected from H, D, an optionally substituted (C₁-C₆)alkyl, and an optionally substituted hetero-(C₁-C₆)alkyl;
R¹⁵-R¹⁶ are each independently an optionally substituted (C₁-C₃)alkyl or an optionally substituted hetero-(C₁-C₃)alkyl; and
x is an integer from 1 to 6.

6. The diamine-appended MOF of claim 1, wherein d is selected from the group consisting of 1,2-diaminopropane, N,N-diethylethylenediamine, 2-(diisopropylamino) ethylamine, N,N′-dimethyl ethylenediamine, N-propylethylenediamine, N-butyl ethylenediamine, N,N-dimethyl-N′-ethylethylenediamine, 1,2-diaminocyclohexane, diethylenetriamine, N-(2-aminoethyl)-1,3-propanediamine, N-isopropyl diethylenetriamine, triethylenetetramine, tris(2-aminoethyl) amine, piperazine, 1-(2-aminoethyl) piperazine, N,N,N′,N′-tetramethyldiamino methane, N,N,N′-trimethylethylenediamine, 3-(dimethylamino)-1-propylamine, 4-(2-aminoethyl)morpholine, N-(2-hydroxyethyl)ethylenediamine; N,N-diethylethylenetriamine, N,N-diisopropylethylenediamine; N,N,N′-trimethylethylenediamine, 1-(2-aminoethyl)-pyrrolidine; 1-(2-aminoethyl)piperidine, and N-(2-hydroxyethyl)ethylenediamine.

7. The diamine-appended MOF of claim 1, wherein d is N,N-diethylethylenediamine or N,N-diisopropylethylenediamine.

8. The diamine-appended MOF of claim 1, wherein M is selected from Be²⁺, Mg²⁺, Ca²⁺, Sr²⁺, Ba²⁺, Sc²⁺, Y²⁺, Ti²⁺, Zr²⁺, V²⁺, Nb²⁺, Ta²⁺, Cr²⁺, Mo²⁺, W²⁺, Mn²⁺, Re²⁺, Fe²⁺, Ru²⁺, Os²⁺, Co²⁺, Rh²⁺, Ir²⁺, Ni²⁺, Pd²⁺, Pt²⁺, Cu²⁺, Ag²⁺, Au²⁺, Zn²⁺, Cd²⁺, Hg²⁺, B²⁺, Al²⁺, Ga²⁺, In²⁺, Si²⁺, Ge²⁺, Sn²⁺, Pb²⁺, As²⁺, Te²⁺, La²⁺, Ce²⁺, Pr²⁺, Nd²⁺, Sm²⁺, Eu²⁺, Gd²⁺, Tb²⁺, Db²⁺, Tm²⁺, Cs²⁺, Yb²⁺, and La²⁺, including any complexes which contain the metal ions, as well as any corresponding metal salt counter-anions.

9. The diamine-appended MOF of claim 8, wherein M is selected from the group consisting of Mg²⁺, Ca²⁺, Ba²⁺, Zr²⁺, V²⁺, Mn²⁺, Fe²⁺, Co²⁺, Ni²⁺, Cu²⁺, Zn²⁺, and Cd²⁺.

10. The diamine-appended MOF of claim 9, wherein M is Mg²⁺.

11. The diamine-appended MOF of claim 1, wherein the diamine-appended MOF is capable of cooperative insertion of CO₂ at a pressure above 1 bar and at a temperature from 30° C. to 80° C.

12. The diamine-appended MOF of claim 1, wherein the diamine-appended MOF is reacted with a post framework reactant that adds at least one effect to the diamine-appended MOF selected from:
modulating the acid gas storage and/or separation ability of the MOF;
modulating the sorption properties of the MOF; and
modulating the pore size of the MOF.

13. A device comprising the diamine-appended MOF of claim 1.

14. The device of claim 13, wherein the device is an acid gas separation and/or acid gas storage device.

15. The device of claim 13, wherein the device comprises the diamine-appended MOF as an acid gas adsorbent.

16-18. (canceled)

19. The device of claim 13, wherein the device is a pressure swing device or a temperature swing device.

20. A method of separating and/or storing one or more acid gases from a fuel gas comprising contacting the fuel gas with a diamine-appended MOF of claim 1.

21. The method of claim 20, wherein the fuel gas is natural gas.

22. (canceled)

23. A process for purifying a stream of natural gas comprising, passing an influent stream of natural gas through a device or material comprising a diamine-appended MOF disclosed in claim 1, wherein the effluent stream comprises less CO₂ than the natural gas influent stream.

24. The process of claim 23, where the device is a pressure swing device or a temperature swing device.

25. An adsorbent material, comprising
a porous metal-organic framework
a diamine with a general molecular formula of NH₂CH₂CH₂NR₂, where —R represents an organic group from selection of —CH₃, CH₂CH₃, CH₂CH₂CH₃, or —CHCH₃CH₃
wherein the diamine-appended metal-organic framework is prepared as a shaped particle, extrudate or pellet
wherein the selection of the diamine is chosen to selectively adsorb CO₂ from a feed gas stream of natural gas including acid gas, water, and methane, ranging in feed pressures from about 50 psia to about 1000 psia with a CO₂ mole fraction from about 5 mol % to about 50 mol %.

26-27. (canceled)

28. A method for removing acid gas from a feed gas stream of natural gas including acid gas, water, and methane, comprising:
alternating input of the feed gas stream between at least two beds of adsorbent particles comprising a diamine-appended metal-organic framework such that the feed gas stream contacts one of the at least two beds at a given time in an adsorption step and a tail gas stream is simultaneously vented from another of the at least two beds in a desorption step;
wherein the contact occurs at a feed pressure of from about 50 to about 1000 psia for a sufficient period of time to preferentially adsorb acid gas from the feed gas stream; thereby producing a product gas stream containing no greater than about 2 mol % carbon; and
wherein the feed gas stream is input at a feed end of each bed; the product gas stream is removed from a product end of each bed; and the tail gas stream is vented from the feed end of each bed.

29. The method of claim 28, wherein the at least two beds of adsorbent particles comprising a diamine-appended metal-organic framework are four beds of adsorbent particles comprising a diamine-appended metal-organic framework; and
wherein the product gas stream contains at least about 80 mol % of methane recovered from the feed gas stream.

30. The method of claim 28, wherein the acid gas adsorbed from the feed gas stream comprises carbon dioxide and from 0 to 1000 ppm hydrogen sulfide.

31. The method of claim 28, wherein the feed gas stream has a flow rate of from 1 to 100 MMSCFD in the adsorption step and the adsorption step occurs at a temperature of from 20 to 80° C.

32. The method of claim 28, wherein the product gas stream contains no greater than about 50 ppm hydrogen sulfide.

33. The method of claim 28, wherein the product gas stream contains no greater than about 4 ppm hydrogen sulfide.

34. The method of claim 28, wherein the acid gas is a gas selected from the group consisting of carbon dioxide, hydrogen sulfide, carbonyl sulfide, combinations thereof, and combinations thereof with water.

35. The method of claim 28, wherein the method utilizes two beds of adsorbent particles comprising diamine-appended metal-organic framework and further comprising:
following the adsorption step in one of the two beds and simultaneous desorption step in the other of the two beds, equalizing pressure of the two beds through the product end of each of the two beds at the end of the adsorption step and simultaneous desorption step; and
repressurizing the bed having just completed the desorption step by sending a slipstream of the product gas stream through the product end of the bed having just completed the desorption step.

36. The method of claim 28, wherein the method is performed on an offshore platform.

37. (canceled)
